(19) United States
(12) Patent Application Publication
(10) Pub. No.: US 2012/0040057 A1
(43) Pub. Date: Feb. 16, 2012

(54) CONFECTIONERIES PROVIDING MOUTH-MOISTENING REFRESHMENT

(76) Inventors: Dino C. Ferri, Lake Hiawatha, NJ (US); Tasoula A. Michaelidou, Bergenfield, NJ (US); Jelena Stojanovic, Montclair, NJ (US); Deborah L. Watson, Haskell, NJ (US)

(21) Appl. No.: 13/201,931

(22) PCT Filed: Feb. 18, 2010
(86) PCT No.: PCT/US10/24565

§ 371 Date: Oct. 27, 2011

Related U.S. Application Data
(60) Provisional application No. 61/153,459, filed on Feb. 18, 2009.

(51) Int. Cl. A23G 3/48; B65D 85/60; A23G 3/54

(52) U.S. Cl. 426/87; 426/536; 426/103

(57) ABSTRACT

The present invention relates to confectioneries that impart a mouth-moistening effect when orally consumed by an individual. Specifically, the confectioneries comprise compositions that include a blend of components comprising spilanthol to reduce or eliminate the perception of mouth dryness in an individual. The confectioneries can further include such components as a sweetening composition, a food-grade acid composition, and a cooling agent composition.

### BACKGROUND OF THE INVENTION

This disclosure relates to compositions and confectioneries that impart a mouth-moistening effect when orally consumed by an individual.

Consumers sometimes desire confectioneries that can provide a refreshing and mouth-watering effect. Some individuals can experience dryness in the mouth from time to time due to a variety of physiological and environmental factors. A dry mouth can be caused by a dry or low humidity environment. A dry mouth can also be caused by reduced levels of saliva and can make an individual's mouth feel sticky and uncomfortable. Some individuals can even suffer from what is referred to as “xerostomia,” a chronic condition of abnormal dryness in the mouth.

A dry mouth can lead to difficulties in tasting, chewing, swallowing, and speaking, as well as to a variety of more serious medical conditions. Prescription medications and artificial saliva are available for severe cases of dry mouth. Individuals experiencing low or moderate levels of mouth dryness, however, often desire consumables that provide a sensation of hydration or mouth moistening. Although water is often sought for relief of mouth dryness, it is not always convenient or portable, and it does not always provide long-lasting relief.

There is a need, therefore, for confectioneries that can provide a sensation of mouth moistening upon consumption. Confectioneries are portable and so can be consumed whenever a feeling of dry mouth is experienced by an individual. Further, mouth moistening in combination with sweetness, flavoring, and refreshing sensations can be an enjoyable experience for the consumer, even in the absence of optional additional functions such as breath or medicinal treatments that can also be contained in a confectionery.

To contribute to a refreshing oral experience, a confectionery product can also contain moderate to high levels of one or more cooling agents. Many substances are known to provide a sensation of cooling on application and are called “cooling agents.” Examples of cooling agents that are trigeminal stimulants include menthol; WS-3; N-substituted p-menthane carboxamido; acyclic carboxamides including WS-23, WS-5, WS-14; methyl succinate; and menthone glycerol ketals. Other cooling compounds can include derivatives of 2,3-dimethyl-2-isopropylbutyric acid such as those disclosed in U.S. Pat. No. 7,030,273, which is incorporated herein by reference. Other examples include isopulegol, 3-(1-menthoxy)propane-1,2-diol, 3-(1-menthoxy)-2-methylpropane-1,2-diol, p-menthane-2,3-diol, p-menthane-3,8-diol, 6-isopropyl-9-methyl-1,4-dioxaspiro[4,5]decane-2-methanol, menthyl succinate and its alkaline earth metal salts, trimethylcyclohexanol, N-ethyl-2-isopropyl-5-methylcyclohexanecarboxamide, Japanese mint oil, peppermint oil, menthone, menthone glycerol ketal, menthyl lactate, 3-(1-menthoxy)ethan-1-ol, 3-(1-menthoxy)propan-1-ol, 3-(1-menthoxy)butan-1-ol, 1-methylacetic acid N-ethylamide, 1-menthyl-4-hydroxypentanoate, 1-menthyl-3-hydroxybutyrate, N,2,3-trimethyl-2-(1-methylethyl)-butanamide, n-ethyl-t-2-c-6 nonadienamide, N,N-dimethyl menthyl succinamide, and menthyl pyrrolidone carboxylate.

Menthol is well known for its physiological cooling effect on the skin and mucous membranes of the mouth. The “cooling” effect of menthol appears to be a physiological effect arising from the direct action of menthol on the nerve endings responsible for the detection of hot and cold. Menthol directly stimulates cold receptors. In addition to its “cooling” effect, menthol also imparts other physiological effects such as “nasal action,” “aroma,” and “minty taste.” Since, however, there are disadvantages associated with using menthol, including its strong minty odor and the harsh notes it imparts to some compositions, efforts have been directed to replacing, reducing, or supplementing menthol with other compounds to provide substantially the same physiological cooling effects but without the disadvantages of menthol alone. For example, some non-menthol compounds providing a physiological effect similar to menthol are described in U.S. Pat. No. 4,296,255 of Rowsell et al. Other compounds exhibiting a physiological cooling effect are described in U.S. Pat. No. 7,030,273 B1 to Sun. Other efforts have also been directed to the development of combinations of cooling agents and other components that can provide a different release profile in confectioneries, for example, which can provide more long-lasting properties. U.S. Patent Application Publication No. US 2005/0019445 A1 of Wolf et al. describes a combination of physiological cooling agents to provide a reduced overall concentration of menthol for a menthol-flavored hard candy.

It can be surmised that a cooling agent or agents and the amounts of each can affect or interact with the mouth-moistening properties of other ingredients in the product in unpredictable ways that can only be determined based on evaluations. Moreover, the effect of the cooling agents on other properties such as mouth-moistening, as well as the effect of combining cooling agents and other ingredients on mouth-moistening and other sensory attributes such as refreshment must be researched and evaluated to obtain the most desirable product for consumers.

U.S. Patent No. 2007/0031561 A1 discloses a composition for a confectionery that imparts a mouth-moistening effect when orally consumed by an individual. More specifically, the composition is a blend of a sweetening composition, food-grade acid composition, and a cooling agent that reduces or eliminates the perception of mouth dryness in an individual. Such compositions can include hard candy as well as chewy candy, chewing gum, and center-filled candies.

The mouth-moistening composition of U.S. Patent Pub. 2007/0031561 A1 (Lakkis et al.) contains a relatively high amount of food-grade acid as well as a cooling agent system that avoids the use of menthol due to its bitterness. A high amount of food-grade acid can produce mouth moistening in the absence of menthol. In addition, food acid can exacerbate the potential bitterness of menthol. Also, high levels of acid can result in candies, especially hard candies, being more hygroscopic and less stable to moisture.

Spilanthol is an alkylamide, (2E,5Z,8E)-deca-2,6,8-trienoic acid N-isobutyl amide, which can be found in the leaves and flowers of such plants as Spilanthes acmella. Spilanthol is known to have trigeminal and saliva-inducing effects. An oleoresin composition extracted from such plants, known as jambu, has been known as a “tingling sensate” for use in confectioneries. Other alkylamides can be present in an extract from jambu. Examples of the use of a jambu oleoresin as a tingling sensate can be found in U.S. Pat. No. 6,780,443. Jambu extracts, however, can produce an annoying tingling sensation from confectioneries in which they are contained. U.S. Pat. No. 6,780,443, which employs jambu in relatively high amounts, requires that jambu be combined with a warmth-producing agent.

Tingling sensates, cooling sensates, and warm sensates can also be generically referred to as “trigeminal stimulants” such as those disclosed in U.S. Patent Application No. 2005/0202118. Trigeminal stimulants are defined as an orally consumed product or agent that stimulates the trigeminal nerve.

There remains a need for new and improved confectioneries that provide a mouth-moistening and refreshing experience, which products will not have unwanted side effects, such as off-flavors, undue sourness, harshness, or annoying tingling. A need still exists for confectioneries that can simultaneously provide both cooling sensations and mouth-moistening. It would be advantageous if the agents did not have the unwanted harshness or flavor characteristics. It would also be desirable to provide a clean, high-quality flavor characterized by long-lasting refreshment.

### BRIEF DESCRIPTION OF THE INVENTION

Disclosed herein is a confectionery product comprising a confectionery composition that comprises:
(a) a cooling agent composition comprising:
   (i) about 0.015 to about 0.15 wt. %, by weight of the confectionery composition, of menthol; and
   (ii) about 0.25 to about 0.15 wt. %, by weight of the confectionery composition, of a physiological cooling compound selected from the group consisting of carboxylamides, menthyl esters, and combinations thereof, wherein the weight ratio of said physiological cooling compound (including the combinations) to menthol is 1:2 to 5:1; and
(b) about 20 to about 60 parts per million, by weight of the confectionery composition, of spilanthol.

One embodiment is a confectionery product comprising a blend that comprises:
(a) a sweetening composition comprising 50 to 99 wt. %, by weight of the confectionery composition, of a sweetening agent selected from the group consisting of a high intensity sweetening agent, a reduced-sweetness sweetening agent, and combinations thereof;
(b) a cooling agent composition comprising:
   (i) 0.025 to 0.15 wt. %, by weight of the confectionery composition, of menthol; and
   (ii) 0.25 to 0.15 wt. %, by weight of the confectionery composition, of a physiological cooling compound selected from the group consisting of carboxylamides, menthyl esters, and combinations thereof, wherein the weight ratio of the physiological cooling compound to menthol is 1:1.5 to 4:1;
(c) about 20 to 60 parts per million, by weight of the confectionery composition, of spilanthol;
(d) a food-grade acid composition; and
(e) a flavor enhancing agent.

Another embodiment is a confectionery product comprising a hard candy that comprises a blend of:
(a) a sweetening composition comprising:
   (i) 90 to 98 wt. %, by weight of the confectionery composition, of a reduced-sweetness sweetening agent comprising isomalt;
   (ii) 0.001 to 5.0 wt. %, by weight of the confectionery composition, of a high intensity sweetening agent comprising sucralose;
(b) a cooling agent composition comprising:
   (i) 0.025 to 1.0 wt. %, by weight of the confectionery composition, of menthol; and
   (ii) 0.25 to 1.0 wt. %, by weight of the confectionery composition, of at least two physiological cooling compounds selected from the group consisting of menthyl glutarate, menthyl succinate, 2,3-trimethyl-2-isopropyl butanamide, N-ethyl p-menthane-3-carboxamide, N-ethyl-2,2-diisopropylbutamide, and combinations thereof, wherein the weight ratio of physiological cooling compounds to menthol is 1:1 to 3:1;
(c) about 20 to 60 parts per million of spilanthol, by weight of the confectionery composition;
(d) a food-grade acid composition comprising malic acid; and
(e) a flavor enhancing agent.

In some embodiments, the addition of jambu provides a significant increase in mouth dryness elimination intensity, in some cases of at least about 0.1, preferably at least about 0.2, and/or an increase in refreshment intensity of at least about 0.1, preferably at least about 0.2, and/or an increase of mouth-watering effect of at least about 0.1, specifically at least about 0.2. Similarly, some embodiments provide a mouth dryness elimination intensity of at least about 3.0 on a scale of 1-5 and/or a refreshment intensity of at least about 3.0 on a scale of 1-5 and/or a mouth-watering effect of at least about 7 on a scale of 1-9.

Some embodiments provide a dividable candy mass comprising a hard candy. Such confectioneries can optionally include, in some embodiments, a center-filled region.

Another embodiment is directed a packaged confectionery product comprising:
(a) a plurality of individual pieces of confectionery, wherein each piece of confectionery includes:
   (i) a cooling agent composition comprising:
   about 0.025 to about 0.15 wt. %, by weight of the confectionery composition, percent menthol; and
   about 0.25 to about 0.15 wt. %, by weight of the confectionery composition, of a physiological cooling compound selected from the group consisting of carboxylamides, menthyl esters, and combinations thereof, wherein the weight ratio of said physiological cooling compound to menthol is 1:2 to 5:1; and
   (ii) about 20 to about 60 parts per million, by weight of the confectionery composition, of spilanthol;
wherein said confectionery pieces have a refreshment intensity of at least about 3.0 on a scale of 1-5 and/or a mouth-watering effect of at least about 6 on a scale of 1-9; and
(b) a package assembly that contains said plurality of individual pieces of confectionery, said package assembly having indicia placed on an outer surface, said indicia being indicative of said refreshment intensity and/or mouth-watering effect.

These and other embodiments are described in detail below.

### DETAILED DESCRIPTION OF THE INVENTION

Embodiments described herein provide a confectionery product that imparts mouth-moistening perception to an individual upon consumption. The compositions can thereby alleviate the feeling of dry mouth that is associated with a variety of physiological and environmental factors. It has unexpectedly been found that the addition of low levels of spilanthol, in combination with a specified cooling agent composition, can provide enhanced mouth-moistening properties and superior refreshment.

As used herein, the term “mouth-moistening” refers to an oral sensation of hydration, which can involve increased salivation that is perceived by an individual during and following consumption of the compositions described herein. The oral sensation of hydration also can refer to a reduced perception of dryness or stickiness in the mouth.

As used herein, the term “confection” or “confectionery” or “confectionery product” may include any conventional hard confectionery or soft confectionery. Such confectioneries include those chewable forms such as soft candies including, but not limited to, gum drops, licorice, fruit snacks, starch based jellies, gelatin based jellies, pectin based jellies, carageenan based jellies, agar based jellies, konjac based jellies, jelly beans, chewy candy, starch candy, nougat, nougatine, toffee, taffy, marshmallow, fondant, fudge, marzipan, chocolate, compound coating, carob coating, chewing gum, and caramel. Also included are confections such as compressed tablets, hard boiled candy, nut brittles, pastilles, pralines, nonpareils, dragees, lozenges, sugared nuts, comfits, and aniseed balls. In one specific embodiment, the confectionery is a hard candy or a confectionery comprising a hard-candy region.

As will be described in detail herein, confectionery compositions, specifically in the form of hard candy, that contain spilanthol in combination with other selected ingredients of a confectionery composition can unexpectedly and desirably relieve a feeling of dry mouth by producing a sensation of mouth moistening, without unwanted properties such as an annoying tingling sensation. In one embodiment, other components of the confectionery composition, such as a low level of sweetness and a slight sourness, which stimulate salivation, and/or long-lasting cooling or refreshment can also contribute to the sensation of mouth moistening or refreshment. Still other factors, such as flavor, texture, shape, and smoothness of the compositions and confectioneries can also contribute to the sensation of mouth-moistening or refreshment.

In some embodiments, the confectionery compositions can include, in addition to spilanthol, a sweetening composition that contains a sugar sweetener or, in combination with a reduced-sweetness sweetening agent, a high intensity sweetening, and a food-grade acid composition. The term “food-grade acid,” as used herein, encompasses any acid that is acceptable for use in edible compositions. Such a blend of components can be used to provide low sweetness and slight sourness, which together can also contribute to a sensory perception of mouth moistening.

In some embodiments, a sweetening composition does not include sugar but includes at least one material in a blend that has a sweetness intensity substantially less than sucrose. Incorporation of specific types of cooling agents can provide an additional desirable characteristic of long-lasting refreshment, which can also contribute to a perception of mouth moistening.

In particular, as indicated above, a confectionery composition, in one embodiment in the form of a hard candy, can comprise, by weight of the confectionery composition, about 20 to about 60 parts per million of spilanthol in a blend comprising about 50 to about 99 wt. %, specifically about 90 to 98 wt. %, of a sweetening composition comprising one or more sugar sweetening agents, one or more high intensity sweetening agents, one or more reduced-sweetness sweetening agents, and combinations thereof; and a cooling agent composition comprising about at least about 0.015 wt. %, specifically 0.025 to about 0.15 wt. % menthol and about 0.025 to about 0.15 wt. % (in total), by weight of the confectionery composition, of one or more physiological cooling compounds comprising carboxylamides, menthyl esters, and combinations thereof, wherein the weight ratio of physiological cooling agents to menthol is 1:2 to 5:1, specifically 1:1.5 to 4:1, more specifically 1.1 to 3:1. In one embodiment, the amount of menthol is not more than 0.1% of the confectionery composition and is less than or equal to the total amount of physiological cooling agents.

In some embodiments, especially in sugarless compositions, the sweetening composition further comprises one or more reduced-sweetness sweetening agents. Specifically, the sweetening composition can comprise 90 to 99 wt. % of one or more reduced-sweetness sweetening agents and, in addition, 0.05 to 5 wt. % of one or more high intensity sweetening agents. A sugarless embodiment can comprise a sweetening composition substantially comprising each of the forenamed components of the sweetening composition. Alternatively, the confectionery composition can comprise, for example, a first sugar sweetening agent that is sucrose and a second sugar sweetening agent that is a glucose-containing syrup. A sugar-containing embodiment can comprise a sweetening composition substantially consisting of sucrose and a glucose-containing syrup. By “substantially consisting” is meant that less than 15 wt. % of the sweetening composition comprises other comparable sweetening materials.

Preferably, the sweetening composition is present in amounts of about 50 to 9 wt. %, specifically 90 to about 98 wt. %, by weight of the confectionery composition. The reduced-sweetness sweetening agent can comprise polyols, sugar alcohols, glycerol, or a combination comprising at least one of the foregoing reduced-sweetness sweetening agents. Specifically, the reduced-sweetness sweetening agent can comprise sorbitol, mannitol, galactitol, maltitol, hydrogenated isomaltulose (isomalt), lactitol, erythritol, hydrogenated starch hydrolysate, stevia, or a combination comprising at least one of the foregoing reduced-sweetness sweetening agents. Preferably, the reduced-sweetness sweetening agent contains isomalt.

A sugar sweetening agent can comprise sucrose, dextrose, maltose, dextrin, xylose, ribose, glucose, mannose, galactose, fructose, lactose, invert sugar, fructo-oligosaccharide syrups, partially hydrolyzed starch, corn syrup solids, high fructose corn syrup, and the like, or a combination comprising at least one of the foregoing sugar sweetening agents.

One embodiment of a confectionery product, for example a hard candy product, comprises a confectionery composition preferably having a water content (or residual moisture) of not more than about 10 wt. %, more preferably about 1 to about 5 wt. %, most preferably 1.5 to 3.0 wt. %, of the confectionery composition. The confectionery product can have smooth or rounded edges. In one example, the confectionery product has a round or oval shape.

The spilanthol that is used to contribute to mouth-moistening in the present product is present at relatively low levels, in order to reduce or minimize its characteristics as a tingling sensate. The compound spilanthol is an unsaturated alkylamide, specifically an isobutylamide, having the chemical name N-isobutyl-2E,6Z,8E-decatrienamide or (2E,6Z,8E)-deca-2,6,8-trienoic acid N-isobutyl amide. Spilanthol can be provided by adding a jambu extract, for example, jambu oleoresin, which contains spilanthol. Other alkylamides extracted from jambu can be included, but spilanthol is the primary one and is typically present in the oleoresin in an amount of 20 to 50 wt. %, specifically 25 to 40 weight percent. Other details of the source and preparation of jambu extracts can be found in U.S. Pat. No. 6,780,443, the entire contents of which are incorporated herein by reference for all purposes. Spilanthol can be obtained from plants, including the leaves and flower heads, of the genera genera Achilla (yarrow), Acmella (spotflower), Echinacea (purple cornflower), and Spilanthes (spilanthes) of the family Asteraceae. The compound spilanthol can also be extracted from grass root (in which spilanthol is referred to as “affinin”). For example, spilanthol is present in Heliopisis longipes roots in concentrations as high as 1 wt. %.

In addition to botanical sources, spilanthol can be prepared synthetically, i.e. not obtained as a natural product. Spilanthol can also be prepared synthetically, as disclosed in WO 2009/091040. Synthetic spilanthol is commercially available, for example, from Takasago International Corp. (Tokyo, JP). Jambu oleoresin (Spilanthes Acmella) or other spilanthol-containing extracts are commercially available from various vendors, including Robertet, Inc. (Grasse, France.)

The confectionery composition for the confectionery product comprises spilanthol in the amount of about 20 to about 60 parts per million, based on total weight of the spilanthol-containing confectionery composition. If the final product is hard candy alone, not center-filled, the concentration is based on the total weight of the final product. Specifically, the confectionery composition comprises spilanthol in the amount of about 22.5 to about 45 ppm. Alternately, the amount of spilanthol can be represented by about 67 to about 200 parts per million, preferably 75 to about 150 parts per million, of jambu oleoresin as a 30 weight percent spilanthol extract of jambu oleoresin, typically in a solvent such as ethanol, based on total weight of the jambu-containing confectionery composition or candy piece of the final product. The amount of oleoresin can be adjusted based on the concentration of spilanthol in a particular jambu oleoresin product or extract. In one embodiment, synthetic spilanthol is present in the product in an amount between 25 and 50 ppm, specifically 30 to 45 ppm. Amounts above about 60 ppm have been found to produce undesirable bitterness, even burning in some formulations.

Synthetic spilanthol, being more pure than botanical sources, can be distinguished to some extent based on taste sensations. Synthetic spilanthol can have a purity of at least about 90 percent. In some embodiments, synthetic spilanthol can provide relatively higher mouth-moistening relative to tingling or heating/cooling sensations, compared to, for example, equivalent amounts of spilanthol in jambu. Synthetic spilanthol can provide a cleaner profile and/or less tingling, based on taste testing, than some comparable plant extracts. In one embodiment a combination of synthetic spilanthol and a spilanthol-containing plant extract is used. For example, within the given range of 20 to 60 ppm spilanthol, the amount of spilanthol provided by synthetic spilanthol can vary from 20 to 80 wt. % and the amount of spilanthol provided by plant extract such as jambu can vary from 80 to 20 wt. %.

Menthol is present in the confectionery composition in an amount of about 0.025 to about 0.15 wt. % menthol, specifically about 0.05 to about 0.10 wt. %, more specifically about 0.040 to about 0.08 wt. %, by weight of the confectionery composition. The menthol can be added as substantially pure crystals or can be added to the confectionery composition in the form of peppermint oil or the like to create “cooling.” Peppermint oil generally comprises about 45-55 wt. % menthol, about 20-25 wt. % menthone, about 5 wt. % menthyl acetate, and about 5 wt. % eucalyptol by weight. Other constituents may be present. Peppermint oil is even used in non-peppermint products, such as spearmint or wintergreen flavored products, in order to create this desired cooling effect.

In addition to menthol, the cooling composition comprises one or more physiological cooling agents. The term “physiological cooling agent,” in the context of this description, does not include traditional cooling agents that are also flavor-derivatives such as menthol or menthone. Preferred physiological cooling agents do not have a perceptible flavor of their own, but are simply used to provide a cooling effect.

While many physiological cooling agents are known for use in confectioneries, the present confectioneries comprise physiological cooling agents comprising acyclic tertiary and secondary carboxylamides, cyclic carboxylamides, menthyl esters, or a combination comprising at least one of the foregoing physiological cooling compounds. U.S. Pat. Nos. 4,060,091; 4,190,643 and 4,136,163, all assigned to Wilkinson Sword, describe acyclic carboxamides and substituted cyclohexane carboxamides, including substituted p-menthane carboxamides (PMC), especially N-ethyl-p-menthane-3-carboxamide (called WS-3); U.S. Pat. Nos. 4,296,255; 4,230,688; and 4,153,679 describe acyclic carboxamides (AC), all also assigned to Wilkinson Sword, especially N-2,3-trimethyl-2-isopropyl butanamide (called WS-23).

The carboxamides in U.S. Pat. No. 4,136,163 are N-substituted-p-menthane-3-carboxamides. The compound N-ethyl-p-menthane-3-carboxamide, commercially available as WS-3 from Wilkinson Sword, is preferred herein. The carboxamides of U.S. Pat. No. 4,230,688 are certain acyclic tertiary and secondary carboxamides, of which N,2,3-trimethyl-2-isopropyl butanamide, commercially available as WS-23 from Wilkinson Sword, is one preferred cooling agent for use herein. Other preferred acyclic carboxamides include acyclic tertiary and secondary carboxamides including the compounds commercially known as Ice 6000, 10000, and 11000. Other cooling compounds include WS-14, N-ethyl-p-menthane-3-carboxamide (WS-3), ethyl 3-(p-menthane-3-carboxamido)acetate (WS-5), N-ethyl-2-isopropyl-5-methylcyclohexanecarboxamide, and the like. U.S. Pat. No. 4,150,052 is incorporated herein by reference with respect to the use of N-ethyl p-menthane-3-carboxamide for its physiological cooling action on the skin.

“Menthyl ester” means a class of compounds such as those described in, for instance, U.S. Pat. No. 3,111,127, U.S. Pat. No. 6,365,215 and U.S. Pat. No. 6,884,906, the disclosures of which are herein incorporated by reference, including monomenthyl succinate, dimenthyl succinate, monomenthyl α,α-dimethyl succinate and monomenthyl 2-methylmaleatementhyl glutarate, FEMA 4006. Methyl ester is also intended to include derivatives thereof, such as, for example, the menthyl half acid ester derivatives set forth in U.S. Pat. No. 6,884,906. The term is also intended to embrace the alkali metal salts and alkaline earth metal salts of the menthyl compounds such as monomenthyl succinate and monomenthyl glutarate. Menthyl esters also include menthyl acetate, 1-menthyl acetate, d,1-menthyl acetate, homomethyl acetate, menthyl lactate, and 1-menthyl lactate. U.S. Pat. Nos. 5,725,865 and 5,843,466 are incorporated herein by reference with respect to the use of mono menthyl succinate for its physiological cooling action.

The term “menthyl glutarate” comprises monomenthyl monomenthyl 2-methylmaleatementhyl glutarate (FEMA 4006), monomenthyl glutarate ester, dimenthyl glutarate ester, a menthyl half acid ester derivative, or a combination comprising at least one of the foregoing menthyl glutarates.

The menthyl ester, L-monomenthyl glutarate, has been registered as a GRAS flavoring substance, FEMA No. 4006 and, in Smith et al., “GRAS Flavoring Substances 20”, Food Technology, Vol. 55, No. 12, December 2001 at page 53, for use in confectioneries among other products, including hard candy.

L-monomenthyl glutarate has the chemical name (L)-monomenthane-3-yl glutarate and is sometimes known as pentadienoic acid or mono[5 methyl-2-1(1-methylethyl)cyclohexyl]ester, [1L]. Monomethyl glutarate, which has the chemical formula C₁₅H₂₆O₄, can be located by JECFA Number 1414 and CAS number 220621-22-7. It is present as a clear viscous fluid having a minty, menthol-like aroma.

A number of the mono menthyl half acid ester derivatives can also be used such as (i) L-menthyl hydrogen adipate (n=3); (ii) L-menthyl hydrogen pimelate (n=4); and (iii) L-menthyl hydrogen suberate (n=5) as disclosed by Rule et al., “Optical Activity and the Polarity of Substituent Groups Part VIII. Growing-chain Effects and the ortho-Effect in Benzoic Esters”, J. Chem. Soc. 1928 (Part 1), pp. 1347-1361.

For example, the cooling agent system can comprise one or more physiological cooling compounds comprising menthyl glutarate, menthyl succinate, 2,3-trimethyl-2-isopropyl butanamide (WS-23), N-ethyl p-menthane-3-carboxamide (WS-3), N-ethyl-2,2-diiisopropylbutamide (ICE 10000® cooling agent), or a combination comprising at least one of the foregoing cooling compounds. Preferably, the cooling agent system comprises a combination of menthyl glutarate and N,2,3-trimethyl-2-isopropyl butanamide. More preferably, the cooling agent system comprises a combination of menthyl glutarate, N,2,3-trimethyl-2-isopropyl butanamide, and N-ethyl p-menthane-3-carboxamide. Most preferably, the cooling agent system consists essentially of menthol and the latter three physiological cooling agents.

In one embodiment, the composition contains one or more first physiological cooling agents comprising one or more menthyl esters and one or more second physiological cooling compounds comprising N-ethyl-p-menthane-3-carboxamide, N-ethyl-2,2-diisopropylbutanamide, N,2,3-trimethyl-2-isopropyl butanamide, or a combination comprising at least one of the foregoing carboxylamides, wherein the confectionary composition, or a confectionary piece or region consisting of the composition, comprises about 0.01 to about 0.10 wt. % of each of the one or more first physiological cooling agents and about 0.01 to about 0.10 wt. % percent of each of the second physiological cooling agents, based on the total weight of the confectionary composition. In one specific embodiment, the cooling agent composition in the confectionery composition comprises from about 50 to about 80 wt. % of menthyl glutarate, about 5 to 15 wt. % of WS-3, about 5 to 15 wt. % of WS-23, and about 2 to 20 wt. % of menthyl succinate, not including menthol.

In one embodiment, the physiological cooling agents consist essentially of one or two menthyl esters, N-ethyl-p-menthane-3-carboxamide, and trimethyl isopropyl butanamide.

All cooling agents, including menthol and physiological cooling agents, can be present in total amounts of about 0.05 wt. % to about 0.5 wt % by weight of the mouth-moistening confectionery composition. In some embodiments, cooling agents can be present in total amounts of about 0.10 wt. % to about 0.30 wt. % by weight. In some embodiments, it can be desirable to provide a confectionery that is low in menthol. Since menthol can cause a sensation of astringency or puckering upon consumption, particularly at high levels, creating a negative impact on hydration, some embodiments can be “low in menthol” (not more than about 0.10 wt. % menthol by weight of the confectionery composition, more specifically not more than about 0.05 wt. % menthol by weight).

In one embodiment, the cooling agent system or composition can be prepared by first providing menthyl glutarate, or at least two menthyl esters in some embodiments, in liquid form. Because menthyl glutarate has a low melting point, it is a liquid at room temperature (about 25° C.). At least one cooling agent selected from N-ethyl-p-menthane-3-carboxamide, trimethyl isopropyl butanamide, and combinations thereof can be added to the liquid menthyl glutarate. N-ethyl-p-menthane-3-carboxamide and trimethyl isopropyl butanamide are both solids at room temperature. Solid cooling agents are typically dissolved in a solvent prior to incorporation into confectioneries. This makes them easier for them to be incorporated into such products. Because menthyl glutarate is a liquid, the solid cooling agents can be dissolved or suspended directly in the liquid menthyl glutarate to form the liquid cooling composition. This can be done at room temperature in the absence of added heat. This composition can be formed as a premix at room temperature. Accordingly, an additional solvent is not needed to dissolve the solid cooling agents.

In some embodiments, it can be desirable to heat the combination of cooling agents to melt the ones that are solids at room temperature. In particular, although menthyl glutarate is a liquid, many cooling agents are solids at room temperature. After being melted, such cooling agents will solidify and recrystallize upon cooling. Such recrystallization can make it difficult to add these cooling agents into confectioneries. For instance, the following cooling agents have melting points near or above room temperature: menthol (43° C.); WS-3 (88° C.); WS-23 (62-64° C.); menthyl lactate (40-42° C.); menthyl succinate (59-61° C.); and menthyl acetate ester (23-24° C.). Once such additional cooling agents are added to menthyl glutarate, for example, to provide at least two menthyl esters, it can be desirable to heat the composition to melt the cooling agents that are solids. For instance, in some embodiments, the composition can be heated to melt WS-3, WS-23 and/or menthol. The composition can be heated to a temperature of at least about 65° C. The liquid composition then can be cooled to less than about 30° C., more specifically about 25° C., while maintaining the composition in a liquid state. This provides a liquid cooling composition that is stable for a period of time at room temperature without recrystallization of the cooling agents that are typically solids at room temperature.

The cooling composition can be blended with the other components of the confectionery composition as further described below, which blend of components imparts a perception of mouth-moistening. The term “blend” refers to a mix, or combination of components, into an integrated whole. In some instances, the separate components or line of demarcation cannot be distinguished. Some embodiments further can include a homogenous blend of the components. The term “homogenous” refers to a uniform blend of the components.

The sweetening composition can include one or more sugar sweetening agents, one or more high intensity sweetening agents, and one or more reduced-sweetness sweetening agents, or a combination comprising at least one of the foregoing sweetening agents. In some embodiments, the sweetening composition can include a blend or pre-mix of a sugar sweetener and one or more sweetening reducing agents. The reduced-sweetness sweetening agent substantially lowers the level of sweetness as compared to sugar. For example, the reduced-sweetness sweetening agent can be a component that replaces some or all of the sugar and effectively reduces the overall sweetness perception of sugar. Reduced levels of sweetness contribute to the sensation of mouth-moistening perceived by the individual user.

In other embodiments, the sweetening composition can include a reduced-sweetness sweetening agent alone or in combination with a high intensity sweetening agent. In some sugarless, or sugar-free, embodiments, the sweetening composition can include at least one non-sucrose saccharide. Some embodiments can include a plurality of non-sucrose saccharides. For example, the sweetening composition can include reduced-sweetness sweetening agents comprising polyols, sugar alcohols, or a combination comprising at least one of the foregoing sweetening agents. Suitable polyols include, but are not limited to, sorbitol, mannitol, maltitol, isomalt, polydextrose, erythritol, lactitol, galactitol, stevia, hydrogenated starch hydrolysates, hydrogenated isomaltulose (isomalt), polyglycitol syrups, and combinations thereof. In such embodiments, the sweetening composition desirably has a sweetness intensity less than the sweetness intensity of sucrose.

The sweetening composition can also comprise a non-sweetener that serves to reduce the sweetness perception of the sweetening composition below the level of a sugar sweetener. Such sweetness reducing agents include, but are not limited to, sweetness inhibiting agents or sweetness receptor blockers, proteins, glycoproteins, oligoproteins, and mixtures thereof.

In some embodiments, the sugarless sweetening agent includes isomalt (PALATINIT®) alone or in combination with maltitol.

Suitable hydrogenated starch hydrolysates can include those disclosed in U.S. Pat. Nos. 4,279,931 and 4,445,938 to Verwaerde et al., and various hydrogenated glucose syrups and/or powders that contain sorbitol, hydrogenated disaccharides, hydrogenated higher polysaccharides, or combinations thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates, such as LYCASIN, a line of commercially available products manufactured by Roquette Freres of France, and HYSTAR, a line of commercially available products manufactured by Lonza, Inc., of Fairlawn, N.J., also can be useful.

Non-sucrose saccharides can also be employed in the confectionery composition to reduce sweetness. In some sugarless embodiments, as described above, the sweetening composition can include at least one non-sucrose saccharide, without sugar. Non-sucrose saccharides include mono-saccharides, di-saccharides, oligo-saccharides and polysaccharides. Suitable examples of non-sucrose saccharides include, but are not limited to: starches, both modified and natural, and starch fractions including amylose and amylopectin; pectins, such as low and high molecular weight methoxy pectins; alginates, such as sodium and potassium; natural and synthetic gums, such as gum arabic, gellan gum, welan gum, gum tragacanth, xanthan gum, guar gum, and locust bean gum; celluloses, such as carboxymethyl cellulose, hydroxypropyl cellulose, hydroxymethyl cellulose, hydroxybutyl carboxymethyl cellulose, hydroxypropylethyl cellulose and methylethyl cellulose; carrageenans, such as alpha-, gamma-, iota-, kappa- and lambda carrageenans; polyols; and combinations thereof.

The confectionery composition can optionally further comprise sweetness inhibiting agents or receptor blockers, which generally act to inhibit the sweet taste perceived in compositions into which they are incorporated. Suitable sweetness inhibitors include, but are not limited to: ethers or thioethers of acetic acid derivatives, as disclosed in U.S. Pat. No. 4,567,053; salts of substituted benzoylalkyl carboxylic acids, as disclosed in U.S. Pat. No. 4,544,565; 3-aminobenzenesulfonic acid and derivatives thereof, as disclosed in U.S. Pat. No. 4,642,240; substituted phenylalkyl carboxylic acid salts and substituted phenyl ketoalkyl carboxylic acid salts, as disclosed in U.S. Pat. No. 4,567,053; substituted benzoyloxy acetic and 2-propionic acid salt derivatives, as disclosed in United Kingdom Patent Application No. 2,180,534; 2-p-methoxyphenoxypropionic acid (commercially available as LACTISOLE from Tate & Lyle); p-methoxybenzylacetic acid; and mixtures thereof. These sweetness inhibitors are described in more detail in the following U.S. patents, each of which is incorporated by reference herein in its entirety: U.S. Pat. No. 5,021,249 to Bunick et al.; U.S. Pat. No. 4,567,053 to Lindley; U.S. Pat. No. 4,544,565 to Barnett; and U.S. Pat. No. 4,642,240 to Barnett et al.

The confectionery composition optionally can further comprise sweetness reducing proteins that can be selected from a wide variety of materials. Suitable proteins include, for example: gelatin; caseins and caseinates; whey proteins; soy proteins; wheat proteins; corn proteins; rice proteins; barley proteins; egg proteins; muscle proteins; proteins from other legumes and tubers; and combinations thereof. Glycoproteins include, for example, chondroitins, glucosaminoglycans and lectins. Glycolipids also can be employed.

Combinations of various reduced-sweetness sweetening agents, non-sucrose saccharides sweetness inhibiting agents, and sweetness reducing proteins also can be employed in some embodiments.

In some embodiments, the reduced-sweetness sweetening agent may be present in amounts of about 0.01% to about 80% by weight of the confectionery composition, more specifically in amounts of about 3% to about 55% by weight. The sweetening composition, i.e., the reduced-sweetness sweetening agents in combination with sugar sweeteners in some embodiments, or reduced-sweetness sweetening agents alone in other embodiments, may be present in amounts of about 0.01% to about 99% by weight of the composition.

Suitable sugar sweeteners for use in the compositions generally include mono-saccharides, di-saccharides and poly-saccharides such as, but not limited to, sucrose (sugar), dextrose, maltose, dextrin, xylose, ribose, glucose, mannose, galactose, fructose (levulose), lactose, invert sugar, fructo oligo saccharide syrups, partially hydrolyzed starch, corn syrup solids, and mixtures thereof.

In some embodiments, high intensity sweeteners also can be included in the confectionery compositions as a complete or partial replacement of sugar sweetener. A high intensity sweetener as used herein means an agent having sweetness at least 100 times, specifically at least 500 times, and more specifically at least 1,000 times, that of a sucrose sugar on a per-weight basis. The high intensity sweetener can be selected from a wide range of materials, including water-soluble sweeteners, water-soluble artificial sweeteners, water-soluble sweeteners derived from naturally occurring water-soluble sweeteners, dipeptide based sweeteners, and protein based sweeteners. Combinations comprising one or more sweeteners or one or more of the foregoing types of sweeteners can be used.

Without being limited to particular high intensity sweeteners, representative categories and examples include:

(a) water-soluble sugar alcohols such as sorbitol, mannitol, maltitol, xylitol, erythritol and L-aminodicarboxylic acid aminoalkenoic acid ester amides, such as those disclosed in U.S. Pat. No. 4,619,834, which disclosure is incorporated herein by reference, and mixtures thereof;

(b) water-soluble artificial sweeteners such as soluble saccharin salts, i.e., sodium or calcium saccharin salts, cyclamate salts, the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, and mixtures thereof;

(c) dipeptide based sweeteners, such as L-aspartic acid derived sweeteners, such as L-aspartyl-L-phenylalanine methyl ester (Aspartame) and materials described in U.S. Pat. No. 3,492,131, L-alphaaspartyl-N-(2,2,4,4-tetramethyl-3-thietanyl)-D-alaninamide hydrate (Alitame), N—[N-(3,3-dimethylbutyl)-L-aspartyl]-L-phenylalanine 1-methyl ester (Neotame), methyl esters of L-aspartyl-L-phenylglycerine and L-aspartyl-L-2,5-dihydrophenyl-glycine, L-aspartyl-2,5-dihydro-L-phenylalanine; L-aspartyl-L-(1-cyclohexen)-alanine, and mixtures thereof;

(d) water-soluble sweeteners derived from naturally occurring water-soluble sweeteners, such as chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include but are not limited to: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructo-furanoside, or 4,1′-dichloro-4,1′-dideoxygalactosucrose; 1′,6′-dichloro1′,6′-dideoxysucrose; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideoxy-beta-D-fructofuranoside, or 4,6,1′,6′-tetrachloro-4,6,1′,6′-tetradeoxygalacto-sucrose; and 4,6,1′,6′-tetradeoxy-sucrose, and mixtures thereof;

(e) protein based sweeteners such as thaumatococcus danielli (Thaumatin I and II) and talin;

(f) the sweetener monatin (2-hydroxy-2-(indol-3-ylmethyl)-4-aminoglutaric acid) and its derivatives; and

(g) the sweeteners rebaudioside A, rebaudioside B, rebaudioside C, rebaudioside D, rebaudioside E, rebaudioside F, dulcoside A, dulcoside B, rubusoside, stevia, stevioside, mogroside IV, mogroside V, Luo Han Quo sweetener (sometimes also referred to as “Lo han kuo” or “Lo han quo”), siamenoside, monatin and its salts (monatin SS, RR, RS, SR), glycyrrhizic acid and its salts, hemandulcin, phyllodulcin, glycyphyllin, dihydroflavenol, dihydrochalcones, phloridzin, trilobtain, baiyunoside, osladin, polypodoside A, pterocaryoside A, pterocaryoside B, mukurozioside, phlomisoside I, periandrin I, abrusoside A, and cyclocarioside I. Such high intensity sweeteners can be used at any suitable purity level. Additionally, the purification of rebaudioside A by crystallization can result in the formation of at least three different polymorphs: a rebaudioside A hydrate; an anhydrous rebaudioside A; and a rebaudioside A solvate. In addition to the at least three polymorph forms of rebaudioside A, the purification of rebaudioside A may result in the formation of an amorphous form of rebaudioside A.

Preferably, the high intensity sweetening agent comprises the potassium salt of 3,4-dihydro-6-methyl-1,2,3-oxathiazine-4-one-2,2-dioxide, L-aspartyl-L-phenylalanine methyl ester, L-alpha-aspartyl-N-(2,2,4,4-tetramethyl-3-thietanyl)-D-alaninamide hydrate, N—[N-(3,3-dimethylbutyl)-L-aspartyl]-L-phenylalanine 1-methyl ester, chlorinated derivatives of sucrose, thaumatin, monatin, mogrosides, or a combination comprising at least one of the foregoing high intensity sweetening agents. More preferably the confectionery composition comprises a high intensity sweetening agent comprising sucralose and acesulfame K.

The intense sweetening agents may be used in many distinct physical forms well-known in the art to provide an initial burst of sweetness and/or a prolonged sensation of sweetness. Without being limited thereto, such physical forms include free forms, such as spray dried, powdered, beaded forms, encapsulated forms, and mixtures thereof.

In general, an effective amount of intense sweetener can be utilized to provide the level of sweetness desired, and this amount can vary with the sweetener selected. The intense sweetener can be present in amounts from about 0.001% to about 5%, by weight of the confectionery, depending upon the sweetener or combination of sweeteners used. The exact range of amounts for each type of sweetener can be selected by those skilled in the art.

As indicated above, the confectionery composition can further comprise a food-grade acid composition. In one embodiment, the food-grade acid composition comprises malic acid. The food-grade acid composition can further comprise acetic acid; adipic acid; ascorbic acid; butyric acid; citric acid; formic acid; fumaric acid; glyconic acid; lactic acid; phosphoric acid; oxalic acid; succinic acid; tartaric acid; or a combination comprising at least one of the foregoing acids. Such food-grade acids can be used alone or in combination with malic acid. In one specific embodiment the food-grade acid composition comprising a combination of malic acid and citric acid.

Food-grade acids stimulate the salivary glands to produce more saliva. The food-grade acid composition can include one or more acids having a pKa of about 1 to about 5.

In general, the food-grade acid composition is present in amounts of about 0.01% to about 10% by weight of the confectionery. In some embodiments, the food-grade acid composition is present in amounts of about 0.05% to about 5% by weight, more specifically about 0.1% to about 1% by weight. Accordingly, malic acid, alone or in combination with other food-grade acids, can be present in amounts of about 0.01% to about 10% by weight of the confectionery, more specifically about 0.05% to about 1.0 wt. % by weight, and even more specifically about 0.2% to about 0.5% by weight.

In some embodiments, the confectionery composition for the product can also comprise one or more flavor enhancing agents (also referred to as flavorants or flavor). Flavor enhancing agents can include flavorants, the taste potentiators described below, and combinations thereof. Suitable flavorants include artificial or natural flavors known in the art, for example, synthetic flavor oils, natural flavoring aromatics and/or oils, oleoresins, extracts derived from plants, leaves, flowers, fruits, or the like, or combinations comprising at least one of the foregoing flavorants. Nonlimiting representative flavors include oils such as spearmint oil, cinnamon oil, oil of wintergreen (methyl salicylate), peppermint oil, clove oil, bay oil, anise oil, eucalyptus oil, thyme oil, cedar leaf oil, oil of nutmeg, allspice, oil of sage, mace, oil of bitter almonds, cassia oil, citrus oils including lemon, orange, lime, grapefruit, vanilla, fruit essences, including apple, pear, peach, grape, strawberry, raspberry, blackberry, cherry, plum, pineapple, apricot, banana, melon, tropical fruit, mango, mangosteen, pomegranate, papaya, and honey lemon essences, and the like, or a combination comprising at least one of the foregoing flavorants. Specific flavorants are mints such as peppermint, spearmint, artificial vanilla, cinnamon derivatives, and various fruit flavors.

Other types of flavorants can include various aldehydes and esters such as cinnamyl acetate, cinnamaldehyde, citral diethylacetal, dihydrocarvyl acetate, eugenyl formate, p-methylamisol, acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2-hexenal (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin). Flavorants can be used in liquid or solid form. With respect to the solid (dry) form, suitable drying means such as spray drying the oil can be used.

The confectionery compositions are of particular utility in confectionery products comprising hard candy. As mentioned above, edible confectioneries can be classified as either “hard” or “soft.” In one embodiment, a hard confectionery product is in the form of a lozenge. In some embodiments, the confectionery can have smooth edges. In such embodiments, the confectionery can have any shape, such as square, circular, or diamond; the edges, however, are preferably rounded to provide a smooth confectionery. Another manner of lending smoothness to the confectioneries is to deposit the confectionery composition into molds during the manufacturing process.

Lubricants also can be added in some embodiments to improve the smoothness of the confectionery, such as, for example, hard candy embodiments. Smoothness also is a characteristic that leads to an increased perception of mouth moistening upon consumption. Suitable lubricants include, but are not limited to, fats, oils, aloe vera, pectin, and combinations thereof.

The confectionery compositions can also be a candy whose center is filled with a hard, soft, or particulate confectionery material. The filling inside a candy of the present composition or in a different region of a multi-layered product containing a candy of the present composition, includes, but is not limited to, chewing gum, chocolate, mint, chewy candy, boiled candies, jelly, fudge, caramel, toffee, taffy, gelatin or gum candy nougat, fondant, powder, or combinations of one or more of these, or edible compositions incorporating one or more of these. In one embodiment, a hard candy of the present composition comprises a soft confectionary as a center filling.

As used herein, the term “center-fill” refers to the innermost region of a confectionery product. The term “center-fill” does not necessarily imply symmetry of a confectionery product, only that the “center-fill” is within another region of the product. In some embodiments, the center-fill may be substantially symmetric and in others, the center-fill may not be symmetric of the confectionery piece. A center-fill may include solid, liquid, gas and mixtures thereof. The term “liquid” in the context of a center-fill includes fluid materials as well as semi-solid or gel materials. The center-fill can be aqueous, non-aqueous, or an emulsion.

The center-fill may be sugar or sugar-free and it may contain fat or be fat-free. Additionally, the center-fill may contain vegetable-based, dairy-based or fruit-based materials such as, but not limited to, fruit juices, fruit concentrates, fruit purees, dried fruit materials, and the like. Further, in some embodiments, the center-fill component may include one or more sweeteners such as those discussed above. The center-fill may also include one or more hydrocolloid materials. Emulsifiers such as glycerides can also be incorporated into the center-fill composition.

In a piece of candy, the spilanthol-containing composition in one region can be separated by means of one or more coatings from a different composition in another region of the product. As used herein, the terms “coating” or “coating region” are used to refer to a region of a confectionery product that at least partially surrounds another region of a confectionery composition, which may be referred to as a confectionary foundation for the coating. In some embodiments, the coating may be amorphous or crystalline and it may be non-particulate or particulate.

In some embodiments, a non-particulate coating may prevent moisture migration between regions of a confectionery product, for example, between a soft center-fill and a hard-candy casing. A non-particulate coating may include a crystalline form of a sugar saccharide or polyol saccharide. In some embodiments, a non-particulate coating is formed when sugar saccharides or polyol saccharides in a confectionery piece to be coated crystallize at the surface of the confectionery foundation. A non-particulate coating may include acids, colors, and flavors. In some embodiments, a coating composition may be in particulate form, crystalline form, or amorphous form, comprising any conventional ingredient such as, but not limited to, salts, sweeteners, flavors, sensates, functional ingredients, and food acids. Particulate coating regions are also known as sanding regions or dusting regions.

A coating may be applied to a confectionery foundation to be coated, as desired, according to conventional processes to create a soft- or hard-panned layer or to create a particulate coating such as a sanding or dusting. For example, a confectionery foundation to be coated can be placed in a rotating pan. A syrup mixture can then be added to the rotating pan in amounts and rates sufficient to coat the individual confectionery foundations. More than one coating can be applied.

In one embodiment, a hard confectionery has a base composed of a mixture comprising sugar or sugar alcohols and other carbohydrate bulking agents, kept in an amorphous or glassy condition. This form comprises a solid syrup of sugars or sugar alcohols generally having from about 0.1 to about 10 wt. %, specifically about 0.5 to about 5 wt. %, most specifically, about 1.0 to about 2.5 wt. % moisture (water). For example, for sugar-containing hard candies, such materials can contain up to about 92 wt. % percent corn syrup, up to about 55 wt. % sugar, and from about 0.1 wt. % to about 5 wt. % water, all based on the total weight of the confectionery composition. The syrup component can be prepared from corn syrups high in fructose, but can include other materials.

The apparatus to prepare such hard candy products, useful in accordance with some embodiments, comprises cooking and mixing apparatus well known in the confectionery manufacturing arts, and selection of the specific apparatus will be apparent to one skilled in the art. In some embodiments, the hard confectioneries are prepared using conventional methods and equipments such as fire cookers, vacuum cookers, or scraped-surface cookers (also referred to as high speed atmospheric cookers). When using a fire cooker, the desired quantity of carbohydrate bulking agent is dissolved in water by heating the agent in a kettle until the bulking agent dissolves. Additional bulking agent can then be added and cooking continued until a final temperature of, for example, 145° to 156° C. is achieved. The batch can then be cooled and worked as a plastic-like mass to incorporate additives separately or in the form of one or more concentrates.

In vacuum cookers, a carbohydrate-bulking agent can be boiled to about 125° to about 132° C., vacuum can be applied, and additional water can be boiled off without extra heating. When cooking is complete, the mass can be a semi-solid and can have a plastic-like consistency. At this point, additives, separate or in the form of one or more concentrates, can be admixed in the mass by routine mechanical mixing operations.

A high-speed atmospheric cooker uses a heat exchanger surface. A film of a hard confectionery composition can spread on a heat exchange surface, rapidly heated to a suitable temperature, for example 165° to 170° C., and then rapidly cooled, for example to 100° to 120° C. Any additives, which may be separate or in the form of one or more concentrates, can then be worked into the plastic mass.

In the foregoing process embodiments, the additives are specifically mixed for a time, for example for about 4 to about 10 minutes, to effectively provide a uniform distribution of these agents. Once the hard confectionery mass has been properly tempered, it can be cut into workable portions or formed into desired shapes as is known in the art.

The process of preparation can be adapted by those skilled in the art to provide solid dosage forms having a desired configuration, including single-layer, multi-layer having two or more layers (e.g., three layers), and forms having a center core.

For optionally filling a confectionery, in one embodiment, the preparation of a soft confectionery, such as nougat, can involve conventional methods, such as the combination of two primary components, namely (1) a high boiling syrup such as a corn syrup, hydrogenated starch hydrolysate or the like, and (2) a relatively light textured frappe. The high boiling syrup, or “bob syrup” of the soft confectionery is relatively viscous and has a higher density than the frappe component, and frequently contains a substantial amount of carbohydrate bulking agent such as a hydrogenated starch hydrolysate. The frappe can be prepared from egg albumin, gelatin, vegetable proteins, such as soy-derived compounds, sugarless milk derived compounds, such as milk proteins, and combinations thereof. The frappe can be relatively light, and can, for example, range in density from about 0.5 to about 0.7 grams/milliliter. Conventionally, the final nougat composition can be prepared by the addition of the bob syrup to the frappe under agitation, to form the basic nougat mixture. For example, the frappe component can be prepared first and thereafter the syrup component can be slowly added under agitation at a suitable temperature, for example, at least about 65° C., and specifically at least about 100° C. After formation of a uniform mixture, the mixture can be cooled, for example, to below about 80° C., at which point additional ingredients such as flavoring, additional carbohydrate bulking agent, coloring agents, preservatives, medicaments, and the like can be added with further mixing. The mixture can then be formed into suitable confectionery shapes.

Further details regarding the preparation of confectionery compositions can be found in Skuse's Complete Confectioner (13th Edition) (1957) including pp. 41-71, 133-144, and 255-262; and Sugar Confectionery Manufacture (2nd Edition) (1995), E. B. Jackson, Editor, pp. 129-168, 169-188, 189-216, 218-234, and 236-258, the content of which is incorporated herein by reference.

In accordance with some embodiments, the sweetening composition, e.g., sugar sweetener, high intensity sweetener, and/or reduced-sweetness sweetening agent, and any additional carrier (e.g., bulk sweetener) as well as a solvent (e.g., water), are combined in a mixing vessel to form a slurry. The slurry is heated to about 70° C. to 120° C. to dissolve any sweetener crystals or particles and form an aqueous solution. Once dissolved, heat at temperatures of about 135° C. to 160° C. and vacuum are applied to cook the batch and boil off water until a residual moisture of less than about 4% is achieved. The batch changes from a crystalline to an amorphous phase. The flavor agent, food-grade acid composition, and cooling agents are then admixed in the batch by mechanical mixing operations, along with any other optional additives, such as coloring agents.

The optimum mixing required to uniformly mix the sweetening compositions, flavors, food-grade acid compositions, cooling agents, colorants, and other additives during manufacturing of a confectionery is determined by the time needed to obtain a uniform distribution of the materials. Normally, mixing times of from 4 to 10 minutes have been found to be acceptable.

In one embodiment, the batch is then cooled to about 100° C. to 20° C. to attain a semi-solid or plastic-like consistency. Once the candy mass has been properly tempered, it can be cut into workable portions or formed into desired shapes having the correct weight and dimensions. A variety of forming techniques can be utilized depending upon the shape and size of the final product desired. Once the desired shapes are formed, cool air can be applied to allow the confectioneries to set uniformly, after which they are wrapped and packaged.

In other embodiments, the mixed batch is deposited into molds of any desired shape and size. Cool air then can be applied to allow the molded confectioneries to set uniformly, after which the confectioneries can be removed, wrapped, and packaged.

Still other confectionery embodiments relate to dividable or, alternatively, molded candy masses. The dividable candy mass can include a mouth-moistening composition, a flavor agent, and, optionally a carrier, as described above. The moldable candy mass can include a mouth-moistening composition which is a molded blend of a sweetening composition, food-grade acid composition, and cooling agent. The molded candy mass also can include a flavor agent and optionally a carrier.

In some embodiments, a confectionery can comprise a center-filled region comprising a powdered confectionery composition. The center-filled composition can include any of the sweeteners, flavors, cooling agents, coloring agents, and the like described herein.

In some embodiments, the center-fill region can include two or more center-fill compositions. The two or more center-fill compositions can be the same or different forms. For example, some embodiments can contain a mixture of two or more distinct liquids, which may or may not be miscible. Similarly, some embodiments can contain two or more distinct solids, semi-solids, or gasses in the center-fill region. Mixtures of different center-fill forms also can be included in some embodiments. For example, a liquid and a solid can be included in the center-fill region. The two or more liquids, solids, semi-solids, and/or gasses employed in the center-fill region can be included in the same or different amounts and can have similar or distinct characteristics. More specifically, in some embodiments, the two or more center-fill compositions can differ in a variety of characteristics, such as, viscosity, color, flavor, taste, texture, sensation, ingredient components, functional components, sweeteners, or the like.

In some embodiments, the center-fill composition also can include non-liquid components, such as, for example, flavor beads, fruit particles, nut particles, flavor particles, gelatin beads, and the like.

Some center-fill embodiments optionally can include a coating region that at least partially surrounds the center-filled region. The coating can be any conventional sugar or sugarless coating, which forms an exterior surface on the center-fill product. A variety of coating processes or mechanisms is known for forming such coatings.

For additional disclosure of various center-fill products and methods of making center-fill products, see the co-pending commonly owned patent application Pub. No. US 2006/0280834 A1 to Jani et al., the contents of which are incorporated herein by reference in their entirety.

In addition to the above-mentioned ingredients, a confectionery composition can contain other additives according to desirability. One or more conventional additives can be used with a confectionery composition, including bulking agents, coloring agents, acidulants, buffering agents, antioxidants, preservatives, nutraceuticals, medicaments, and the like. Some of these additives can serve more than one purpose. For example, a sweetener, e.g., sucrose, sorbitol, or other sugar alcohol, or combinations of the foregoing sweeteners, can also function as a bulking agent. A combination comprising at least one of the foregoing additives is often used.

Bulking agents can include sweetening agents listed above and other suitable agents such as minerals. Specific examples can include monosaccharides, disaccharides, polysaccharides, sugar alcohols, polydextrose, and maltodextrins.

Coloring agents can include pigments, which can be incorporated in amounts up to about 6% by weight of the composition. For example, titanium dioxide can be incorporated in amounts up to about 2%, and preferably less than about 1%, by weight of the composition. The colorants can also include natural food colors and dyes suitable for food, drug, and cosmetic applications. These colorants are known as FD&C dyes and lakes. The materials acceptable for the foregoing uses are preferably water-soluble. Illustrative nonlimiting examples include the indigoid dye known as FD&C Blue No. 2, which is the disodium salt of 5,5-indigotindisulfonic acid. Similarly, the dye known as FD&C Green No. 1 comprises a triphenylmethane dye and is the monosodium salt of 4-[4-(N-ethyl-p-sulfoniumbenzylamino)diphenylmethylene]-[1-(N-ethyl-N-p-sulfoniumbenzyl)-delta-2,5-cyclohexadieneimine]. A full recitation of all FD&C colorants and their corresponding chemical structures can be found in the Kirk-Othmer Encyclopedia of Chemical Technology, 3rd Edition, in volume 5 at pages 857-884, which text is incorporated herein by reference.

Taste potentiators are substances capable of reducing or eliminating undesirable tastes in edible substances. Taste potentiators can also serve to enhance desirable tastes in edible substances such as sweetness potentiators that increase sweetness intensity. In the context of cooling agents, taste potentiators can be effective to reduce or eliminate bitterness, undesired mintiness, or other undesired taste. The taste potentiator compositions can have controlled-release properties. The taste potentiator can work synergistically with the cooling agent to enhance the perception of the cooling agent. In some embodiments, delivery of a sweetener in combination with a taste potentiator can enhance the sweet taste upon consumption of the composition. The incorporation of the potentiator, therefore, can allow for reduced amounts of cooling agent and/or sweetener without compromising the levels of cooling and sweetness provided by the composition.

Any of a variety of substances that function as taste potentiators can be employed in the compositions described herein. For instance, suitable taste potentiators include water-soluble taste potentiators, such as, but not limited to, neohesperidin dihydrochalcone, chlorogenic acid, alapyridaine, cynarin, miraculin, glupyridaine, pyridinium-betain compounds, glutamates, such as monosodium glutamate and monopotassium glutamate, neotame, thaumatin, tagatose, trehalose, salts, such as sodium chloride, monoammonium glycyrrhizinate, vanilla extract (in ethyl alcohol), water-soluble sugar acids, potassium chloride, sodium acid sulfate, water-soluble hydrolyzed vegetable proteins, water-soluble hydrolyzed animal proteins, water-soluble yeast extracts, adenosine monophosphate (AMP), glutathione, water-soluble nucleotides, such as inosine monophosphate, disodium inosinate, xanthosine monophosphate, guanylate monophosphate, alapyridaine (N-(1-carboxyethyl)-6-(hydroxymethyl)pyridinium-3-ol inner salt, sugar beet extract (alcoholic extract), sugarcane leaf essence (alcoholic extract), curculin, strogin, mabinlin, gymnemic acid, 2-hydroxybenzoic acid (2-HB), 3-hydroxybenzoic acid (3-HB), 4-hydroxybenzoic acid (4-HB), 2,3-dihydroxybenzoic acid (2,3-DHB), 2,4-dihydroxybenzoic acid (2,4-DHB), 2,5-dihydroxybenzoic acid (2,5-DHB), 2,6-dihydroxybenzoic acid (2,6-DHB), 3,4-dihydroxybenzoic acid (3,4-DHB), 3,5-dihydroxybenzoic acid (3,5-DHB), 2,3,4-trihydroxybenzoic acid (2,3,4-THB), 2,4,6-trihydroxybenzoic acid (2,4,6-THB), 3,4,5-trihydroxybenzoic acid (3,4,5-THB), 4-hydroxyphenylacetic acid, 2-hydroxyisocaproic acid, 3-hydroxycinnamic acid, 3-aminobenzoic acid, 4-aminobenzoic acid, 4-methoxysalicylic acid and combinations thereof.

Other suitable taste potentiators are substantially or completely insoluble in water, such as, but not limited to, citrus aurantium, vanilla oleoresin, water insoluble sugar acids, water insoluble hydrolyzed vegetable proteins, water insoluble hydrolyzed animal proteins, water insoluble yeast extracts, insoluble nucleotides, sugarcane leaf essence, and combinations thereof.

Some other suitable taste potentiators include substances that are slightly soluble in water, such as, but not limited to, maltol, ethyl maltol, vanillin, slightly water-soluble sugar acids, slightly water-soluble hydrolyzed vegetable proteins, slightly water-soluble hydrolyzed animal proteins, slightly water-soluble yeast extracts, slightly water-soluble nucleotides, and combinations thereof.

As mentioned above, sweetener potentiators, which are a type of taste potentiator, enhance the taste of sweetness. Exemplary sweetener potentiators include, but are not limited to, monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, sugar beet extract, neotame, thaumatin, neohesperidin dihydrochalcone, tagatose, trehalose, maltol, ethyl maltol, vanilla extract, vanilla oleoresin, vanillin, sugar beet extract (alcoholic extract), sugarcane leaf essence (alcoholic extract), compounds that respond to G-protein coupled receptors (T2Rs and T1Rs, 2-hydroxybenzoic acid (2-HB), 3-hydroxybenzoic acid (3-HB), 4-hydroxybenzoic acid (4-HB), 2,3-dihydroxybenzoic acid (2,3-DHB), 2,4-dihydroxybenzoic acid (2,4-DHB), 2,5-dihydroxybenzoic acid (2,5-DHB), 2,6-dihydroxybenzoic acid (2,6-DHB), 3,4-dihydroxybenzoic acid (3,4-DHB), 3,5-dihydroxybenzoic acid (3,5-DHB), 2,3,4-trihydroxybenzoic acid (2,3,4-THB), 2,4,6-trihydroxybenzoic acid (2,4,6-THB), 3,4,5-trihydroxybenzoic acid (3,4,5-THB), 4-hydroxyphenylacetic acid, 2-hydroxyisocaproic acid, 3-hydroxycinnamic acid, 3-aminobenzoic acid, 4-aminobenzoic acid, 4-methoxysalicylic acid, and combinations thereof.

Additional taste potentiators for the enhancement of salt taste include acidic peptides, such as those disclosed in U.S. Pat. No. 6,974,597 to Ohta et al. Perillartine also can be added as described in U.S. Pat. No. 6,159,509 to Johnson et al. Still additional taste potentiators include those described, for example, in U.S. Pat. Nos. 5,631,038 and 6,008,250 to Kurtz et al. In some embodiments, the taste potentiator can comprise 3-hydroxybenzoic acid and a dihydroxybenzoic acid selected from the group consisting of 2,4-dihydroxybenzoic acid, 3,4-dihydroxybenzoic acid, and combinations thereof. Confectionery salts, such as sodium, potassium salts, calcium, magnesium, and ammonium salts, can be substituted for the free acids in these potentiator combinations.

Any of the above-listed taste potentiators can be used alone or in combination. Some embodiments, for instance, can include two or more taste potentiators that act synergistically with one another. For instance, in some embodiments, a sweetener potentiator composition can be provided, which includes two or more sweetener potentiators that act synergistically with one another. The sweetener potentiator composition can enhance the sweetness of products into which it is incorporated by reducing the amount of sucrose needed to provide a sweetness intensity equivalent to sucrose. The sweetness enhancing effect of the combination of sweetener potentiators can be greater than the effect of either compound used individually.

Warming agents can include a wide variety of compounds known to provide the sensory signal of warming to the user. These compounds offer the perceived sensation of warmth, particularly in the oral cavity, and often enhance the perception of flavors, sweeteners, and other organoleptic components. Suitable warming agents include vanillyl alcohol n-butylether (TK-1000) supplied by Takasago Perfumary Company Limited, Tokyo, Japan, vanillyl alcohol n-propylether, vanillyl alcohol isopropylether, vanillyl alcohol isobutylether, vanillyl alcohol n-aminoether, vanillyl alcohol isoamyl ether, vanillyl alcohol n-hexyl ether, vanillyl alcohol methyl ether, vanillyl alcohol ethyl ether, gingerol, shogaol, paradol, zingerone, capsaicin, dihydrocapsaicin, nordihydrocapsaicin, homocapsaicin, homodihydrocapsaicin, ethanol, isopropyl alcohol, isoamyl alcohol, benzyl alcohol, glycerine, and a combination comprising at least one of the foregoing. In some embodiments, a warming agent and a cooling agent can be incorporated into spatially distinct regions of the confectionery. Preferably, warming agents are essentially absent from the present confectionery composition.

Breath fresheners can include zinc citrate, zinc acetate, zinc fluoride, zinc ammonium sulfate, zinc bromide, zinc iodide, zinc chloride, zinc nitrate, zinc fluorosilicate, zinc gluconate, zinc tartarate, zinc succinate, zinc formate, zinc chromate, zinc phenol sulfonate, zinc dithionate, zinc sulfate, silver nitrate, zinc salicylate, zinc glycerophosphate, copper nitrate, chlorophyll, copper chlorophyll, chlorophyllin, hydrogenated cottonseed oil, chlorine dioxide, beta cyclodextrin, zeolite, silica-based material, carbon-based material, enzymes such as laccase, or a combination comprising at least one of the foregoing. Breath fresheners can include essential oils as well as various aldehydes and alcohols. Essential oils used as breath fresheners can include oils of spearmint, peppermint, wintergreen, sassafras, chlorophyll, citral, geraniol, cardamom, clove, sage, carvacrol, eucalyptus, cardamom, magnolia bark extract, marjoram, cinnamon, lemon, lime, grapefruit, orange, or a combination comprising at least one of the foregoing. Aldehydes such as cinnamic aldehyde and salicylaldehyde can be used. Additionally, chemicals such as carvone, iso-garrigol, and anethole can function as breath fresheners.

Suitable additional mouth moisteners can include hydrocolloid materials that hydrate and can adhere to oral surfaces to provide a sensation of mouth moistening. Hydrocolloid materials can include naturally occurring materials such as plant exudates, seed gums, and seaweed extracts or they can be chemically modified materials such as cellulose, starch, or natural gum derivatives. Furthermore, hydrocolloid materials can include pectin, gum arabic, acacia gum, alginates, agar, carageenans, guar gum, xanthan gum, locust bean gum, gelatin, gellan gum, galactomannans, tragacanth gum, karaya gum, curdlan, konjac, chitosan, xyloglucan, beta glucan, furcellaran, gum ghatti, tamarin, and bacterial gums. Mouth moisteners can include modified natural gums such as propylene glycol alginate, carboxymethyl locust bean gum, low methoxyl pectin, or a combination comprising at least one of the foregoing. Modified celluloses can be included such as microcrystalline cellulose, carboxymethylcellulose (CMC), methylcellulose (MC), hydroxypropylmethylcellulose (HPCM), hydroxypropylcellulose (HPC), or a combination comprising at least one of the foregoing mouth moisteners.

Suitable acidulants can include sodium bicarbonate and carbonate, sodium or potassium phosphate and magnesium oxide, potassium metaphosphate, sodium acetate, or a combination comprising at least one of the foregoing acidulants.

Exemplary buffering agents can include sodium bicarbonate, sodium phosphate, sodium hydroxide, ammonium hydroxide, potassium hydroxide, sodium stannate, triethanolamine, citric acid, hydrochloric acid, sodium citrate, or a combination comprising at least one of the foregoing buffering agents.

Antioxidants can include butylated hydroxytoluene (BHT), butylated hydroxyanisole (BHA), propyl gallate, and combinations thereof.

Suitable nutraceuticals can include herbs and botanicals such as aloe, bilberry, bloodroot, calendula, capsicum, chamomile, cat's claw, echinacea, garlic, ginger, ginkgo, goldenseal, various ginseng, green tea, guarana, kava kava, lutein, nettle, passionflower, rosemary, saw palmetto, St. John's wort, thyme, and valerian. Also included are mineral supplements such as calcium, copper, iodine, iron, magnesium, manganese, molybdenum, phosphorous, zinc, and selenium. Other nutraceuticals can include fructooligosaccharides, glucosamine, grapeseed extract, cola extract, guarana, ephedra, inulin, phytosterols, phytochemicals, catechins, epicatechin, epicatechin gallate, epigallocatechin, epigallocatechin gallate, isoflavones, lecithin, lycopene, oligofructose, polyphenols, flavanoids, flavanols, flavonols, and psyllium as well as weight loss agents such as chromium picolinate and phenylpropanolamine. Exemplary vitamins and co-enzymes include water or fat soluble vitamins such as thiamin, riboflavin, nicotinic acid, pyridoxine, pantothenic acid, biotin, folic acid, flavin, choline, inositol and para-aminobenzoic acid, carnitine, vitamin C, vitamin D and its analogs, vitamin A and the carotenoids, retinoic acid, vitamin E, vitamin K, vitamin B₆, and vitamin B₁₂. Combinations comprising at least one of the foregoing nutraceuticals can be used.

Moreover, the relative amount of each of the above additives of the confectionery composition will depend on the particular composition and the additive, as well as the desired flavor, and are readily determined by one of ordinary skill in the art without undue experimentation.

Suitable medicaments can include oral care agents, throat care agents, allergy relief agents, and general medical care agents.

Suitable oral care agents can include breath fresheners, tooth whiteners, antimicrobial agents, tooth mineralizers, tooth decay inhibitors, topical anesthetics, mucoprotectants, stain removers, oral cleaning, bleaching agents, desensitizing agents, dental remineralization agents, antibacterial agents, anticaries agents, plaque acid buffering agents, surfactants and anticalculus agents, and a combination comprising at least one of the foregoing. Non-limiting examples of such ingredients can include hydrolytic agents such as proteolytic enzymes, abrasives such as hydrated silica, calcium carbonate, sodium bicarbonate and alumina, other active stain-removing components such as surface-active agents, including anionic surfactants such as sodium stearate, sodium palmitate, sulfated butyl oleate, sodium oleate, salts of fumaric acid, glycerol, hydroxylated lecithin, sodium lauryl sulfate and chelators such as polyphosphates, which are typically employed as tartar control ingredients. Oral care agents can also include tetrasodium pyrophosphate and sodium tri-polyphosphate, sodium bicarbonate, sodium acid pyrophosphate, sodium tripolyphosphate, xylitol, sodium hexametaphosphate, peroxides such as carbamide peroxide, calcium peroxide, magnesium peroxide, sodium peroxide, hydrogen peroxide, and peroxydiphospate.

In addition, oral care ingredients can also include antibacterial agents comprising triclosan, chlorhexidine, zinc citrate, silver nitrate, copper, limonene, and cetyl pyridinium chloride.

Anticaries agents can include fluoride ions, fluorine-providing components (e.g., inorganic fluoride salts), soluble alkali metal salts (e.g., sodium fluoride, potassium fluoride, sodium fluorosilicate, ammonium fluorosilicate, potassium fluoride, sodium monofluorophosphate), and tin fluorides, (e.g., stannous fluoride and stannous chloride, potassium stannous fluoride (SnF₂-KF), sodium hexafluorostannate, stannous chlorofluoride).

One embodiment is a confectionery composition further comprising a throat care agent or throat-soothing agent. Throat care or throat-soothing agents can include analgesics, antihistamines, anesthetics, demulcents, mucolytics, expectorants, antitussive, and antiseptics. In some embodiments, the throat care agent is honey, propolis, aloe vera, aloe ferox, glycerine, menthol, or a combination comprising at least one of the foregoing.

In accordance with the present invention, to determine the effectiveness of the confectioneries at satisfying the desired attributes, trained taste panels are employed. For example, a number of different confectioneries, each containing different mouth-moistening compositions, can be provided to a particular taste panel. Upon consumption of each confectionery, the panel can rate a number of attributes based on predetermined scales, which are commonly accepted in the art.

For instance, the ability of the confectionery to reduce or eliminate mouth dryness can be rated on an intensity scale. Intensity scales commonly include a rating scale of 1-5, with 1 being not at all effective and 5 being extremely effective, as described in Morten Meilgaard et al., “Sensory Evaluation Techniques” 247 (3d ed. 1999). In some embodiments, the confectionery can have a mouth dryness elimination intensity of at least about 3.0 on such a scale.

The ability of the confectioneries to provide refreshment also can be measured by such an intensity scale. In accordance therewith, some embodiments can have a refreshment intensity of at least about 3.0 on such a scale of 1-5.

The ability of the confectioneries to provide a mouth-watering effect can be measured on a different type of scale, i.e., a hedonic scale. Hedonic scales measure the level of liking for the specified attribute, as described in “Sensory Evaluation Techniques,” referred to above, at pages 242-43. For instance, how much the mouth-watering effect of a confectionery is liked or disliked can be rated on a hedonic scale of 1-9, with 1 being disliked extremely and 9 being liked extremely. In some embodiments, the confectionery can have a mouth-watering effect of at least about 6 on such a scale.

Other attributes are typically tested as well. One text covering all the basic techniques of sensory testing is Sensory Evaluation of Food: Principles & Practices, by Harry T. Lawless and Hildegarde Heymann, the disclosure of which is herein incorporated by reference. Statistics used in sensory evaluation are demonstrated as integrated applications in the context of appropriate sensory methods and are also presented as stand-alone material in appendices. Statistical applications are tailored to common analyses encountered in sensory work, together with instructions on how tests should be conducted.

For example, a panel of respondents can be assembled for sensory evaluation. Attribute terms for evaluation of samples are selected. Normally, ballot development and respondent training are carried out initially. Descriptive terms are developed for major sensory attribute categories. Exemplary attribute qualities include aroma, flavor, texture, aftertaste, sweetness, etc. Attributes are quantified with an intensity scale of from, e.g., 0 to 10; where 0 indicates that the attribute is not detected and 10 indicates the attribute is extremely strong. Overall quality rating can be measured with a scale of from, e.g., 1 to 10 where less than 6 is considered “poor,” 6 to 7 is “fair,” and 8 to 10 is “good.”

Overall quality ratings and quantified intensity ratings can be analyzed with commercially available software programs. Descriptive statistical measures can be calculated for all attributes. Analysis of variance can be performed on each attribute using a randomized block design for balanced data with panelists as repeated measures as described by Ott, “Analysis of variance for some standard experimental designs,” pp. 844-856 in An Introduction to Statistical Methods and Data Analysis. Wadsworth Publishing, Belmont, Calif. Where F-test indicates a significant difference between treatment means, Tukey paired comparisons and orthogonal comparisons can be used to determine where the means are different. Significance of differences can be defined as P less than 0.05. Principal components analysis (PCA) can be applied with the factor analysis described by Lawless and Heymann, 1998, pp. 606-608 in Sensory Evaluation of Food: Principles and Practices. Chapman & Hall, New York, 1998. PCA can be applied to the attributes. Attributes can be omitted if the values are consistently low indicating that the attribute is not often present, if the attribute has a high standard deviation or if the attribute is highly correlated to another attribute. Kaiser's criterion can be applied (eigen value greater than 1) to determine the number of final factors from the initial ones as described by Massart et al., “Principal components and factor analysis,” pp. 339-369 in Chemometrics: A Textbook. Elsevier, Amsterdam, 1988. To facilitate the interpretation of results, the factors can be orthogonally rotated leading to uncorrelated factors following the Varimax method described by Massart et al., supra.

The overall quality ratings (dependent variables) can be modeled as a function of the Varimax rotated PC scores for the products (independent variables). Models can be constructed using ordinary least squares (OLS), principal components regression (PCR), and partial least squares regression (PLS) routines in applicable software. PCR and PLS models can be calculated with, for instance, one to four components. In each case, the best fit equations (those with the highest R²) and those with the best predictive ability (lowest residual predictive sum of squares or the like) are obtained.

Further, respondents can score each product at various time points, for example, 1 minute, 15 minutes, and 30 minutes for overall liking and intensity of four attributes: flavor, sweetness, cooling/warming, and texture. A 15-minute rest period can be provided between each product allowing for palate cleansing.

The invention is further illustrated by the following non-limiting examples.

### EXAMPLES

Fifteen confectionery formulations in the form of 3.1 gram oval drops are prophetically prepared as follows. These examples illustrate the use of a range of spilanthol in a candy for achieving desirable mouth-moistening and refreshment attributes. The candies are prepared by suitably mixing the ingredients as described in general above.

The fifteen different formulations contain various flavors for the candy. The formulations of Examples 1-14 exemplify sugarless formulations and the formulation of Example 15 exemplifies a center-filled sugar-containing formulation. In the following Tables, various combinations of menthyl glutarate, menthyl succinate, WS-23, and WS-3, are used. Ace-sulfame K refers to the potassium salt of 3,4-dihydro-6-methyl-1,2,3-oxathiazine-4-one-2,2-dioxide, commercially available from Clariant, Ltd. (Switzerland).

### Examples 1-2

Strawberry flavored hard candy in the form of 3.1 gram oval drops are produced having the formulations shown in Table 1 with respect to individual components and weight ranges for each component (parts by weight or pbw). The amount of jambu oleoresin in Example 1 is 0.0075 parts by weight, and the amount of jambu oleoresin in Example 2 is 0.015 parts by weight, based on 100 parts total.

TABLE 1

| Component | Ex. 1 (pbw) | Ex. 2 (pbw) |
|---|---|---|
| Isomalt | 96.49 | 96.48 |
| Water | 2.00 | 2.00 |
| Citric Acid Anhydrous | 0.30 | 0.30 |
| Malic Acid | 0.30 | 0.30 |
| Acesulfame K | 0.045 | 0.045 |
| Sucralose | 0.060 | 0.060 |
| Menthol Crystals | 0.095 | 0.095 |
| Menthyl glutarate | 0.050-0.080 | 0.050-0.080 |
| Menthyl succinate | 0.002-0.01 | 0.002-0.01 |
| WS-3 cooling agent | 0.005-0.015 | 0.005-0.015 |
| WS-23 cooling agent | 0.005-0.015 | 0.005-0.015 |
| Jambu (30% spilanthol) | 0.0075 | 0.015 |
| Purple Speckles (1 mm) | 0.30 | 0.30 |
| Flavor—Strawberry | 0.30 | 0.30 |
| Color—Red 40 | 0.0011 | 0.0011 |

These confectionery compositions provide superior mouth-moistening attributes.

### Examples 3-4

Lemon-lime flavored hard candy in the form of 3.1 gram oval drops are produced having the formulations shown in Table 2 with respect to individual components and weight ranges for each component. The amount of jambu oleoresin in Example 3 is 0.015 parts by weight, and the amount of jambu oleoresin in Example 4 is 0.0075 parts by weight, based on 100 parts total.

TABLE 2

| Component | Ex. 3 (pbw) | Ex. 4 (pbw) |
|---|---|---|
| Isomalt | 96.05 | 96.06 |
| Water | 2.00 | 2.00 |
| Citric Acid Anhydrous | 0.38 | 0.38 |
| Malic Acid | 0.38 | 0.38 |
| Acesulfame K | 0.045 | 0.045 |
| Sucralose | 0.060 | 0.060 |
| Menthol Crystals | 0.095 | 0.095 |
| Menthyl glutarate | 0.050-0.080 | 0.050-0.080 |
| Menthyl succinate | 0.002-0.01 | 0.002-0.01 |
| WS-3 cooling agent | 0.005-0.015 | 0.005-0.015 |
| WS-23 cooling agent | 0.005-0.015 | 0.005-0.015 |
| Jambu 30% spilanthol | 0.015 | 0.0075 |
| Purple Speckles | 0.30 | 0.30 |
| Flavor—lemon-lime | 0.58 | 0.58 |
| Color—beta Carotene 2% emulsion | 0.084 | 0.0084 |

These confectionery compositions provide superior mouth-moistening attributes.

### Examples 5-6

Mint flavored hard candy in the form of 3.1 gram oval drops are produced having the formulations shown in Table 3 with respect to individual components and weight ranges for each component (parts by weight or pbw). The amount of jambu oleoresin in Example 5 is 0.019 parts by weight, and the amount of jambu oleoresin in Example 6 is 0.015 parts by weight, based on 100 parts total. Malic acid, without citric acid, is employed in this example. Instead of a separate menthol component, menthol is contained in the flavor agent.

TABLE 3

| Component | Ex. 5 (pbw) | Ex. 6 (pbw) |
|---|---|---|
| Isomalt | 96.80 | 96.80 |
| Water | 2.00 | 2.00 |
| Malic Acid | 0.10 | 0.10 |
| Acesulfame K | 0.045 | 0.045 |
| Sucralose | 0.060 | 0.060 |
| Menthyl glutarate | 0.050-0.080 | 0.050-0.080 |
| Menthyl succinate | 0.002-0.01 | 0.002-0.01 |
| WS-3 cooling agent | 0.005-0.015 | 0.005-0.015 |
| WS-23 cooling agent | 0.005-0.015 | 0.005-0.015 |
| Jambu 30% spilanthol | 0.019 | 0.015 |
| Purple Speckles (1 mm) | 0.30 | 0.30 |
| Flavor—mint | 0.58 | 0.58 |
| Color—Blue 1 | 0.00030 | 0.00030 |

These confectionery compositions provide superior mouth-moistening attributes.

### Examples 7-8

Spearmint flavored hard candy in the form of 3.1 gram oval drops are produced having the formulations shown in Table 4 with respect to individual components and weight ranges for each component (parts by weight or pbw). The amount of jambu oleoresin in Example 7 is 0.019 parts by weight, and the amount of jambu oleoresin in Example 8 is 0.015 parts by weight, based on 100 parts total. Again, no citric acid, in addition to malic acid, is necessary in this example, and separate menthol is employed in addition to that contained in the spearmint oil flavor.

TABLE 4

| Component | Ex. 7 (pbw) | Ex. 8 (pbw) |
|---|---|---|
| Isomalt | 97.041 | 97.04 |
| Water | 2.00 | 2.00 |
| Malic Acid | 0.10 | 0.10 |
| Acesulfame K | 0.045 | 0.045 |
| Sucralose | 0.060 | 0.060 |
| Menthol Crystals | 0.035 | 0.035 |
| Menthyl glutarate | 0.050-0.080 | 0.050-0.080 |
| Menthyl succinate | 0.0020-0.01 | 0.002-0.01 |
| WS-3 cooling agent | 0.005-0.015 | 0.005-0.015 |
| WS-23 cooling agent | 0.005-0.015 | 0.005-0.015 |
| Jambu 30% spilanthol | 0.019 | 0.015 |
| Purple Speckles (1 mm) | 0.30 | 0.30 |
| Flavor—Spearming oil | 0.30 | 0.30 |
| Color—Blue 1 | 0.00030 | 0.00030 |

These confectionery compositions provide superior mouth-moistening attributes.

### Examples 9-12

Strawberry pepper flavored hard candy in the form of 3.1 gram oval drops are produced having the formulations shown in Table 5 with respect to individual components and weight ranges for each component (parts by weight or pbw). The amount of jambu oleoresin in Examples 9 and 11 is 0.015 parts by weight, and the amount of jambu oleoresin in Examples 10 and 12 is 0.0075 parts by weight, based on 100 parts total. The amount of strawberry pepper flavor also varies with the amount of the jambu. The amount of strawberry pepper flavor in Examples 9 and 10 is 0.27 parts by weight, and the amount strawberry pepper flavor in Examples 11 and 12 is 0.58 parts by weight, based on 100 parts total.

TABLE 5

| Component | Ex. 9 (pbw) | Ex. 10 (pbw) | Ex. 11 (pbw) | Ex. 12 (pbw) |
|---|---|---|---|---|
| Isomalt | 96.31 | 96.32 | 96.00 | 96.01 |
| Water | 2.00 | 2.00 | 2.00 | 2.00 |
| Citric Acid | 0.40 | 0.40 | 0.40 | 0.40 |
| Anhydrous | | | | |
| Malic Acid | 0.40 | 0.40 | 0.40 | 0.40 |
| Acesulfame K | 0.045 | 0.045 | 0.045 | 0.45 |
| Sucralose | 0.060 | 0.060 | 0.060 | 0.060 |
| Menthol | 0.095 | 0.095 | 0.095 | 0.095 |
| Crystals | | | | |
| Menthyl | 0.050-0.080 | 0.050-0.080 | 0.050-0.080 | 0.050-0.080 |
| glutarate | | | | |
| Menthyl | 0.002-0.01 | 0.002-0.01 | 0.002-0.01 | 0.002-0.01 |
| succinate | | | | |
| WS-3 cooling | 0.005-0.015 | 0.005-0.015 | 0.005-0.015 | 0.005-0.015 |
| agent | | | | |
| WS-23 cooling | 0.005-0.015 | 0.005-0.015 | 0.005-0.015 | 0.005-0.015 |
| agent | | | | |
| Jambu 30% | 0.015 | 0.0075 | 0.015 | 0.0075 |
| spilanthol | | | | |
| Purple | 0.30 | 0.30 | 0.30 | 0.30 |
| Speckles | | | | |
| (1 mm) | | | | |
| Flavor—Straw- | 0.27 | 0.27 | 0.58 | 0.58 |
| berry Pepper | | | | |
| Color—Red 40 | 0.0011 | 0.0011 | 0.0011 | 0.0011 |

These confectionery compositions provide superior mouth-moistening attributes.

### Examples 13-14

Tropical twist flavored hard candy in the form of 3.1 gram oval drops are produced having the formulations shown in Table 6 with respect to individual components and weight ranges for each component (parts by weight or pbw). The amount of jambu oleoresin in Example 13 is 0.0075 parts by weight and the amount of jambu oleoresin in Example 14 is 0.015 parts by weight, based on 100 parts total.

TABLE 6

| Component | Ex. 13 (pbw) | Ex. 14 (pbw) |
|---|---|---|
| Isomalt | 96.29 | 96.29 |
| Water | 2.00 | 2.00 |
| Citric Acid Anhydrous | 0.25 | 0.25 |
| Malic Acid | 0.25 | 0.25 |
| Acesulfame K | 0.045 | 0.045 |
| Sucralose | 0.060 | 0.060 |
| Menthol Crystals | 0.095 | 0.095 |
| Menthyl glutarate | 0.050-0.080 | 0.050-0.080 |
| Menthyl succinate | 0.002-0.01 | 0.002-0.01 |
| WS-3 cooling agent | 0.005-0.015 | 0.005-0.015 |
| WS-23 cooling agent | 0.005-0.015 | 0.005-0.015 |
| Jambu 30% spilanthol | 0.0075 | 0.015 |
| Purple Speckles (1 mm) | 0.30 | 0.30 |
| Flavor—tropical twist | 0.60 | 0.60 |
| Color 1—beta carotene 2% | 0.0045 | 0.0045 |
| emulsion | | |
| Color 2—Red 40 | 0.00015 | 0.00015 |

These confectionery compositions provide superior mouth-moistening attributes.

### Example 15

A center-filled hard candy based on sugar sweetener is produced having the formulation shown in Table 7 with respect to individual components and weight ranges for each component (parts by weight or pbw). The amount of jambu oleoresin is 0.015 parts by weight, based on 100 parts total.

TABLE 7

| Component | Ex. 15 (pbw) |
|---|---|
| Sugar, granulated | 48.32 |
| Corn Syrup | 48.32 |
| Water | 2.00 |
| Citric Acid Anhydrous | 0.25 |
| Malic Acid | 0.25 |
| Menthol Crystals | 0.10 |
| Menthyl glutarate | 0.050-0.080 |
| Menthyl succinate | 0.002-0.01 |
| WS-3 cooling agent | 0.005-0.015 |
| WS-23 cooling agent | 0.005-0.015 |
| Jambu 30% spilanthol | 0.01502 |
| Flavor 1—Tropical | 0.60 |
| Flavor 1—Strawberry | 0.20 |
| Flavor 2—Paprika | 0.0150 |
| Center Fill—Xylitol Powder | 6.5-7.0 |

The confectionery product having the composition of Table 7 provides superior mouth-moistening attributes.

### Example 16

Flavored hard candy in the form of 3.78 gram oval drops are produced having the formulations shown in Table 8 with respect to individual components and weights or weight ranges for each component (parts by dry weight). The amount of jambu used is 75 ppm (parts per million by weight), based on 100 parts total, which is calculated to contain about 22.5 ppm spilanthol based on a 30 wt. % concentration of jambu.

The isomalt candy base is cooked to 145° C. and the color and the high intensity sweetener in solution are added. A premix containing the other components in Table 8, including flavor and acid components, is cooked to 175° C. A given amount of candy base is poured onto a table, and the premix added into the cooked candy base. The candy is kneaded to a proper consistency and speckles added. The kneaded candy is drop rolled into 3.78 g ovals.

TABLE 8

| Component | Dry weight (g) |
|---|---|
| Isomalt | 382.64 |
| High intensity sweetener | 0.42 |
| component | |
| Menthol Crystals | 0.11 |
| Acid Component | 3.20 |
| Menthyl glutarate | 0.19-0.31 |
| Menthyl succinate | 0.0078-0.039 |
| WS-3 cooling agent | 0.019-0.058 |
| WS-23 cooling agent | 0.019-0.058 |
| Jambu | 0.030 |
| Flavor | 1.20 |
| Colors | 0.018 |

The confectionery product having the composition of Table 8 provides superior mouth-moistening attributes. For a hard candy having a formulation in accordance with that shown in Table 8, a panel consisting of eight tasters provided their qualitative feedback as summarized below following Examples 16-21.

### Example 17

Flavored hard candy in the form of 3.78 gram oval drops are produced having the formulations shown in Table 9 with respect to individual components and weight ranges for each component (parts by dry weight). Synthetic spilanthol is used instead of a jambu extract containing spilanthol. The amount of synthetic spilanthol is 25 ppm (parts per million by weight), based on 100 parts total.

The isomalt candy base is cooked to 145° C. and the color and the high intensity sweetener in solution are added. A premix containing the other components in Table 9, including the flavor and acid components, is cooked to 175° C. A given amount of candy base is poured onto a table, and the flavor premix added into the cooked candy base. The candy is kneaded to a proper consistency and speckles added. The kneaded candy is drop rolled into 3.78 g ovals.

TABLE 9

| Component | Dry Weight (g) |
|---|---|
| Isomalt | 382.47 |
| High Intensity sweetener | 0.42 |
| component | |
| Acid component | 3.20 |
| Menthol crystals | 0.11 |
| Menthyl glutarate | 0.19-0.31 |
| Menthyl succinate | 0.0078-0.039 |
| WS-3 cooling agent | 0.19-0.058 |
| WS-23 cooling agent | 0.019-0.058 |
| Synthetic spilanthol | 0.010 |
| Flavor | 1.20 |
| Color | 0.018 |

The confectionery product having the composition of Table 9 provides superior mouth-moistening attributes. A panel consisting of eight tasters provided their qualitative feedback on hard candy having a formulation in accordance with that shown in Table 9, as summarized below following Examples 16-21.

### Example 18

Flavored hard candy in the form of 3.78 gram oval drops are produced having the formulations shown in Table 10 with respect to individual components and weight ranges for each component (parts by dry weight). Synthetic spilanthol is used instead of jambu extract containing spilanthol. The amount of synthetic spilanthol is 50 ppm (parts per million by weight), based on 100 parts total.

The isomalt candy base is cooked to 145° C. and the color and the high intensity sweetener in solution are added. A premix containing the other components in Table 10, including flavor and acid components, is cooked to 175° C. A given amount of candy base is poured onto a table, and the premix added into the cooked candy base. The candy is kneaded to a proper consistency and speckles added. The kneaded candy is drop rolled into 3.78 g ovals.

TABLE 10

| Component | Dry Weight (g) |
|---|---|
| Isomalt | 382.27 |
| High Intensity sweetener | 0.42 |
| component | |
| Acid component | 3.20 |
| Menthol crystals | 0.11 |
| Menthyl glutarate | 0.19-0.31 |
| Menthyl succinate | 0.0078-0.039 |
| WS-3 cooling agent | 0.19-0.058 |
| WS-23 cooling agent | 0.019-0.058 |
| Synthetic spilanthol | 0.020 |
| Flavor | 1.20 |
| Color | 0.018 |

The confectionery product having the composition of Table 10 provides superior mouth-moistening attributes. A panel consisting of eight tasters provided their qualitative feedback on hard candy having a formulation in accordance with that shown in Table 10, as summarized below following Examples 16-21.

### Comparative Example 18

Flavored hard candy in the form of 3.78 gram oval drops are produced having the formulations shown in Table 11 with respect to individual components and weight ranges for each component (parts by dry weight). Synthetic spilanthol is used instead of jambu containing spilanthol. The amount of synthetic spilanthol is 75 ppm (parts per million by weight), based on 100 parts total.

The isomalt candy base is cooked to 145° C. and the color and the high intensity sweetener in solution are added. A premix containing the other components in Table 11, including the flavor and acid components, is cooked to 175° C. A given amount of candy base is poured onto a table, and the premix added into the cooked candy base. The candy is kneaded to a proper consistency and speckles added. The kneaded candy is drop rolled into 3.78 g ovals.

TABLE 11

| Component | Dry Weight (g) |
|---|---|
| Isomalt | 382.07 |
| High intensity sweetener | 0.42 |
| component | |
| Menthol crystals | 0.11 |
| Acid component | 3.2 |
| Menthyl glutarate | 0.19-0.31 |
| Menthyl succinate | 0.0078-0.039 |
| WS-3 cooling agent | 0.19-0.058 |
| WS-23 cooling agent | 0.019-0.058 |
| Synthetic spilanthol | 0.03 |
| Flavor | 1.2 |
| Color | 0.018 |

The confectionery product having the composition of Table 11 provides mouth-moistening attributes. A panel consisting of eight tasters provided their qualitative feedback on hard candy having a formulation in accordance with that shown in Table 11, as summarized below following Examples 16-21.

### Example 19

Another flavored hard candy in the form of 3.78 gram oval drops is produced having the formulations shown in Table 12 with respect to individual components and weight ranges for each component (parts by dry weight). The amount of jambu is 75 ppm (parts per million by weight), based on 100 parts total, which is calculated to contain 22.5 ppm spilanthol based on 30 wt. % concentration in jambu. The total amount of physiological cooling agents (not including menthol) is 0.10 wt. % in the final product.

The isomalt candy base is cooked to 145° C. and the color and the high intensity sweetener in solution are added. A premix containing the other components in Table 12, including the acid and flavor components is cooked to 175° C. A given amount of candy base is poured onto a table, and the premix added into the cooked candy base. The candy is kneaded to a proper consistency and speckles added. The kneaded candy is drop rolled into 3.78 g ovals.

TABLE 12

| Component | Dry Weight (g) |
|---|---|
| Isomalt | 478.81 |
| High intensity sweetener | 0.525 |
| component | |
| Menthol crystals | 0.28 |
| Acid component | 3.0 |
| Menthyl glutarate | 0.24-0.39 |
| Menthyl succinate | 0.0097-0.048 |
| WS-3 cooling agent | 0.024-0.073 |
| WS-23 cooling agent | 0.024-0.073 |
| Jambu | 0.038 |
| Flavor | 1.50 |
| Color | 0.0053 |

The confectionery product having the composition of Table 12, in which 75 ppm jambu is present, provides superior mouth-moistening attributes according to taste testing. A panel consisting of eight tasters provided their qualitative feedback on hard candy having a formulation in accordance with that shown in Table 12, as summarized below following Examples 16-21.

### Example 20

A flavored hard candy in the form of 3.78 gram oval drops is produced having the formulations shown in Table 13 with respect to individual components and weight ranges for each component (parts by dry weight). Synthetic spilanthol is used instead of jambu extract containing spilanthol. The amount of synthetic spilanthol is 35 ppm (parts per million by weight), based on 100 parts total.

The isomalt candy base is cooked to 145° C. and the color and the high intensity sweetener in solution are added. A premix containing the other components of Table 13, including the flavor and acid components, is cooked to 175° C. A given amount of candy base is poured onto a table, and the premix added into the cooked candy base. The candy is kneaded to a proper consistency and speckles added. The kneaded candy is drop rolled into 3.78 g ovals.

TABLE 13

| Component | Parts by Weight (g) |
|---|---|
| Isomalt | 478.84 |
| High intensity sweetener | 0.525 |
| component | |
| Menthol crystals | 0.28 |
| Acid component | 3.0 |
| Menthyl glutarate | 0.24-0.39 |
| Menthyl succinate | 0.0097-0.048 |
| WS-3 cooling agent | 0.024-0.073 |
| WS-23 cooling agent | 0.024-0.073 |
| Synthetic spilanthol | 0.035 |
| Flavor | 1.50 |
| Color | 0.0053 |

The flavored confectionery product having the composition of Table 13 provides superior mouth-moistening attributes. A panel consisting of eight tasters provided their qualitative feedback on hard candy having a formulation in accordance with that shown in Table 13, as summarized below following Examples 16-21.

### Example 21

A flavored hard candy in the form of 3.78 gram oval drops is produced having the formulations shown in Table 14 with respect to individual components and weight ranges for each component (parts by dry weight). Synthetic spilanthol is used instead of jambu extract containing spilanthol. The amount of synthetic spilanthol is 40 ppm (parts per million by weight), based on 100 parts total.

The isomalt candy base is cooked to 145° C. and the color and high intensity sweetener in solution are added. A premix containing the other components in Table 14, including the flavor and acid components, is cooked to 175° C. A given amount of candy base is poured onto a table, and premix added into the cooked candy base. The candy is kneaded to a proper consistency and speckles added. The kneaded candy is drop rolled into 3.78 g ovals.

TABLE 14

| Component | Dry Weight (g) |
|---|---|
| Isomalt | 478.79 |
| High intensity sweetener | 0.525 |
| component | |
| Menthol crystals | 0.28 |
| Acid component | 3.00 |
| Menthyl glutarate | 0.24-0.39 |
| Menthyl succinate | 0.0097-0.048 |
| WS-3 cooling agent | 0.024-0.073 |
| WS-23 cooling agent | 0.024-0.073 |
| Synthetic spilanthol | 0.040 |
| Flavor | 1.50 |
| Color | 0.0053 |

The flavored confectionery product having the composition of Table 14 provides superior mouth-moistening attributes.

As mentioned above, various hard candies having formulations in accordance with those described in the above Examples 16-21 were presented to a panel of tasters in order to obtain qualitative feedback principally concerning mouth moistening attributes and relative tingling sensations.

For a formulation such as disclosed in Example 16, in which jambu is present in the amount of 75 ppm (approximately 22.5 ppm spilanthol), based on 100 parts total, a panel of eight tasters reported mouth-moistening attributes as well as dual warming and cooling sensation. For a formulation such as disclosed in Example 17, in which synthetic spilanthol is present in the amount of 25 ppm (parts per million by weight), based on 100 parts total, a panel of eight tasters reported mouth-moistening sensation with little or no tingling effects. For a formulation such as disclosed in Example 18, in which the amount of synthetic spilanthol is 50 ppm (parts per million by weight), based on 100 parts total, a panel of eight tasters reported relatively less tingling sensation and earlier mouth-moistening sensation, compared to 75 ppm jambu, which contains a lesser corresponding amount of spilanthol. This amount of synthetic spilanthol (50 ppm) also was found to provide relatively increased mouth moistening compared to 25 ppm synthetic spilanthol. A higher amount of spilanthol, however, can cause flavor changes and bitterness for some tasters, as indicated by Comparative Example 18.

For a formulation such as disclosed in Comparative Example 18, in which the amount of synthetic spilanthol is 75 ppm (parts per million by weight), based on 100 parts total, a panel of eight tasters reported a harsh taste and an unpleasant tingling/tickling. Thus, a level of 75 ppm synthetic spilanthol was found to be too high for a desired product.

For formulations such as disclosed in Examples 19-21, a tasting session compared confectioneries with 35 ppm and 40 ppm levels of synthetic spilanthol, respectively, to a confectionery with 75 ppm jambu (approximately 22.5 ppm spilanthol). It was found that the synthetic spilanthol approximated the mouth-moistening attributes of the formulation with jambu. Although these confectioneries all provided superior mouth-moistening attributes, the confectioneries comprising synthetic spilanthol were found to provide relatively less tingling in profile.

This written description uses examples to disclose the invention, including the best mode, and also to enable any person skilled in the art to make and use the invention. The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A confectionery product comprising a confectionery composition that comprises:
(a) a cooling agent composition comprising:
(i) about 0.015 to about 0.15 wt. %, by weight of the confectionery composition, of menthol; and
(ii) about 0.025 to about 0.15 wt. %, by weight of the confectionery composition, of a physiological cooling compound selected from the group consisting of carboxylamides, menthyl esters, and combinations thereof, wherein the weight ratio of said physiological cooling compound (ii) to menthol (i) is 1:2 to 5:1; and
(b) about 20 to about 60 parts per million, by weight of the confectionery composition, of spilanthol.

2. The confectionery product of claim 1, wherein the confectionery composition further comprises:
(c) a sweetening composition comprising about 50 to about 99 wt. %, based on the weight of the confectionery, of a sweetening agent selected from the group consisting of sugar sweetening agent, a high intensity sweetening agent, a reduced-sweetness sweetening agent, and combinations thereof.

3. The confectionery product of claim 2, wherein the sweetening composition comprises a reduced-sweetness sweetening agent.

4. The confectionery product of claim 3, wherein the sweetening composition comprises 0.001 to 5 wt. % of one or more high intensity sweetening agents and 90 to 99 wt. % of one or more reduced-sweetness sweetening agents.

5. The confectionery product of claim 2, wherein the sweetening composition comprises a first sugar sweetening agent that is sucrose and a second sugar sweetening agent that is a glucose-containing syrup.

6. The confectionery product of claim 1, wherein the confectionery composition further comprises a food-grade acid composition and a flavor enhancing agent.

7. The confectionery product of claim 6, wherein said food-grade acid composition is present in amounts of about 0.01% to about 5% by weight of said confectionery composition.

8. The confectionery product of claim 7, wherein said food-grade acid composition comprises malic acid.

9. The confectionery product of claim 6, wherein said food-grade acid composition comprises acetic acid; adipic acid; ascorbic acid; butyric acid; citric acid; formic acid; fumaric acid; glyconic acid; lactic acid; phosphoric acid; oxalic acid; succinic acid; tartaric acid; or a combination comprising at least one of the foregoing.

10. The confectionery product of claim 6, wherein said food-grade acid composition comprises a combination of malic acid and citric acid.

11. The confectionery product of claim 1, wherein said cooling agent composition comprises a physiological cooling compound selected from the group consisting of acyclic tertiary or secondary carboxylamides, cyclic carboxylamides, menthyl esters, and combinations thereof.

12. The confectionery product of claim 11, wherein said cooling agent composition comprises a physiological cooling compound selected from the group consisting of menthyl glutarate, menthyl succinate, 2,3-trimethyl-2-isopropyl butanamide, N-ethyl p-menthane-3-carboxamide, N-ethyl-2,2-diiisopropylbutamide, and combinations thereof.

13. The confectionery product of claim 1, wherein said cooling agent composition comprises a combination of menthyl glutarate and N,2,3-trimethyl-2-isopropyl butanamide.

14. The confectionery product of claim 1, wherein said cooling agent composition comprises a combination of menthyl glutarate, N,2,3-trimethyl-2-isopropyl butanamide, and N-ethyl p-menthane-3-carboxamide.

15. The confectionery product of claim 1, wherein the total amount of said cooling agent composition, consisting of menthol and physiological cooling agents, is about 0.10 wt. % to about 0.25 wt. %, by weight of said confectionery composition.

16. The confectionery product of claim 1, wherein the confectionery composition comprises a first physiological cooling agent that is a menthyl ester and a second physiological cooling compound selected from the group consisting of N-ethyl-p-menthane-3-carboxamide, N-ethyl-2,2-diisopropylbutanamide, N,2,3-trimethyl-2-isopropyl butanamide, and combinations thereof; and wherein the confectionary composition comprises about 0.01 to about 0.10 wt. % of the first physiological cooling agent and about 0.01 to about 0.10 wt. % of the second physiological cooling agent, based on the total weight of the composition.

17. The confectionery product of claim 2, wherein said sweetening composition is present in the amount of about 90% to about 98% by weight of said confectionery composition.

18. The confectionery product of claim 2, wherein said reduced-sweetness sweetening agent is selected from the group consisting of polyols, sugar alcohols, glycerol, and combinations thereof.

19. The confectionery product of claim 18, wherein said reduced-sweetness sweetening agent is selected from the group consisting of sorbitol, mannitol, galactitol, maltitol, hydrogenated isomaltulose (isomalt), lactitol, erythritol, hydrogenated starch hydrolysate, stevia, and combinations thereof.

20. The confectionery product of claim 19, wherein said reduced-sweetness sweetening agent is isomalt.

21. The confectionery product of claim 5, wherein said glucose-containing syrup is corn syrup.

22. The confectionery product of claim 6, wherein said flavor enhancing agent is a citrus flavor, a strawberry flavor, a mint flavor, or a spearmint flavor.

23. The confectionery product of claim 1, wherein the confectionery composition in the confectionery product exhibits a mouth dryness elimination intensity of at least about 0.2 higher than in the absence of the spilanthol.

24. The confectionery product of claim 1, wherein the confectionery composition in said confectionery product exhibits a refreshment intensity of at least about 3.0 on a scale of 1-5 and/or a mouth-watering effect of at least about 6 on a scale of 1-9.

25. The confectionery product of claim 1, wherein said confectionery composition has a water content of not more than about 5 wt. % of the confectionery composition.

26. The confectionery product of claim 1, wherein said confectionery product comprises hard candy, soft candy, or a combination comprising at least one of the foregoing.

27. The confectionery product of claim 26, wherein said confectionery product has smooth edges or is rounded.

28. The confectionery product of claim 26, wherein said confectionery product further comprises a center-filled region.

29. The confectionery product of claim 28, wherein said center-filled region includes a polyol that is erythritol, xylitol, or a combination comprising at least one of the foregoing.

30. The confectionery product of claim 29, wherein said polyol is in particulate form.

31. The confectionery product of claim 1, further comprising a coating region separating the confectionery composition from another confectionery composition.

32. The confectionery product of claim 2, wherein said sweetening composition is sugarless.

33. The confectionery product of claim 1, wherein said spilanthol in the confectionary composition is present in a plant extract.

34. The confectionery product of claim 1, wherein said spilanthol in the confectionery composition is a synthetic compound.

35. The confectionery product of claim 1, wherein said spilanthol in the confectionery composition is a blend of a synthetic spilanthol and a spilanthol-containing plant extract.

36. A confectionery product, comprising a confectionery composition that is a blend comprising:
(a) a sweetening composition comprising 50 to 98 wt. %, by weight of the confectionery composition, of a sweetening agent selected from the group consisting of a high intensity sweetening agent, a reduced-sweetness sweetening agent, and combinations thereof;
(b) a cooling agent composition comprising:
(i) 0.025 to 0.15 wt. %, by weight of the confectionery composition, of menthol; and
(ii) 0.025 to 0.15 wt. %, by weight of the confectionery composition, of a physiological cooling compound selected from the group consisting of carboxylamides, menthyl esters, and combinations thereof, wherein the weight ratio of physiological cooling agent (ii) to menthol (i) is 1:2 to 5:1;
(c) about 20 to 60 parts per million, by weight of the confectionery composition, of spilanthol;
(d) a food-grade acid composition; and
(e) a flavor enhancing agent.

37. The confectionery product of claim 36, wherein the cooling agent composition comprises physiological cooling agents consisting essentially of one or two menthyl esters, N-ethyl-p-menthane-3-carboxamide, and trimethyl isopropyl butanamide.

38. The confectionery product of claim 36, wherein the cooling agent composition comprises a menthyl glutarate comprising monomenthyl monomenthyl 2-methylmaleatementhyl glutarate (FEMA 4006), monomenthyl glutarate ester, dimenthyl glutarate ester, a menthyl half acid ester derivative, or a combination comprising at least one of the foregoing menthyl glutarates.

39. The confectionery product of claim 36, wherein the cooling agent composition comprises at least two menthyl esters selected from the group consisting of monomenthyl monomenthyl 2-methylmaleatementhyl glutarate (FEMA 4006), monomenthyl glutarate ester, dimenthyl glutarate ester, a menthyl half acid ester derivative, menthyl acetate, 1-menthyl acetate, d,1-menthyl acetate, homomethyl acetate, menthyl lactate, 1-menthyl lactate, menthyl succinate, and monomenthyl succinate.

40. The confectionery product of claim 39, wherein said menthyl succinate is present and is monomenthyl succinate, dimenthyl succinate, monomenthyl α,α-dimethyl succinate, or a combination comprising at least one of the foregoing menthyl succinates.

41. The confectionery product of claim 36, wherein the sweetening composition comprises a high intensity sweetening agent selected from the group consisting of the potassium salt of 3,4-dihydro-6-methyl-1,2,3-oxathiazine-4-one-2,2-dioxide, L-aspartyl-L-phenylalanine methyl ester, L-alpha-aspartyl-N-(2,2,4,4-tetramethyl-3-thietanyl)-D-alaninamide hydrate, N—[N-(3,3-dimethylbutyl)-L-aspartyl]-L-phenylalanine 1-methyl ester, chlorinated derivatives of sucrose, thaumatin, monatin, mogrosides, rebaudiosides, steviosides, and combinations thereof.

42. The confectionery product of claim 36, wherein the sweetening composition comprises a high intensity sweetening agent comprising sucralose and acesulfame K.

43. The confectionery product of claim 36, wherein the sweetening composition comprises a sugar sweetening agent selected from the group consisting of sucrose, dextrose, maltose, dextrin, xylose, ribose, glucose, mannose, galactose, fructose, lactose, invert sugar, fructooligosaccharide syrups, partially hydrolyzed starch, and corn syrup solids, high fructose corn syrup, and combinations thereof.

44. The confectionery product of claim 36, wherein the sweetening composition comprises sucrose and glucose-containing syrup.

45. A confectionery product comprising a confectionery composition that is a blend comprising:
(a) a sweetening composition comprising:
(i) 90 to 98 wt. %, by weight of the confectionery composition, of a reduced-sweetness sweetening agent comprising isomalt;
(ii) 0.5 to 5.0 wt. %, by weight of the confectionery composition, of a high intensity sweetening agent comprising sucralose;
(b) a cooling agent composition comprising:
(i) 0.025 to 0.10 wt. %, by weight of the confectionery composition, of menthol; and
(ii) 0.025 to 0.10 wt. %, by weight of the confectionery composition, of at least two physiological cooling compounds selected from the group consisting of menthyl glutarate, menthyl succinate, 2,3-trimethyl-2-isopropyl butanamide, N-ethyl p-menthane-3-carboxamide, N-ethyl-2,2-diiisopropylbutamide, and combinations thereof, wherein the weight ratio of physiological cooling agents to menthol is 1:2 to 5:1;
(c) about 20 to 60 parts per million, by weight of the confectionery composition, of spilanthol;
(d) a food-grade acid composition comprising malic acid; and
(e) a flavor enhancing agent.

46. A packaged confectionery product comprising:
(a) a plurality of individual pieces of confectionery, wherein each piece of confectionery comprises a confectionery composition comprising:
(i) a cooling agent composition comprising:
about 0.025 to about 0.15 wt. %, by weight of the confectionery composition, of menthol; and
about 0.025 to about 0.15 wt. %, by weight of the confectionery composition,
of a physiological cooling compound selected from the group consisting of carboxylamides, menthyl esters, and combinations thereof, wherein the weight ratio of said physiological cooling compound (i) to menthol (ii) is 1:2 to 5:1; and
(ii) about 20 to about 60 parts per million, by weight of the confectionery composition, of spilanthol;
wherein said confectionery pieces have a refreshment intensity of at least about 3.0 on a scale of 1-5 and/or a mouth-watering effect of at least about 6 on a scale of 1-9; and
(b) a package assembly that contains said plurality of individual pieces of confectionery, said package assembly having indicia placed on an outer surface, said indicia being indicative of said refreshment intensity and/or mouth-watering effect.

47. A packaged confectionery product comprising:
(a) a plurality of individual pieces of confectionery, wherein each piece of confectionery includes a confectionery composition comprising:
(i) a cooling agent composition comprising:
about 0.025 to about 0.15 wt. %, by weight of the confectionery composition, of menthol; and
about 0.025 to about 0.15 wt. % of a physiological cooling compound selected from the group consisting of carboxylamides, menthyl esters, and combinations thereof, wherein the weight ratio of said physiological cooling compound to menthol is 1:2 to 5:1; and
(ii) about 20 to about 60 parts per million, by weight of the confectionery composition, of spilanthol;
wherein the addition of the spilanthol to said confectionery pieces provide an increase in mouth-watering effect of at least about 0.2, based on the confectionery pieces having a mouth-watering effect of at least about 6 on a scale of 1-9; and
(b) a package assembly that contains said plurality of individual pieces of confectionery, said package assembly having indicia placed on an outer surface, said indicia being indicative of said spilanthol providing said mouth-watering effect.
